(19) United States
(12) Patent Application Publication
(10) Pub. No.: US 2016/0357840 A1
(43) Pub. Date: Dec. 8, 2016

(54) APPARATUS AND METHOD FOR CLUSTERING DATA IN STREAMING CLUSTERING WITHOUT REDUCING PRECISION

(71) Applicant: FUJITSU LIMITED, Kawasaki-shi (JP)

(72) Inventors: Shigeyuki ODASHIMA, Tama (JP); Miwa Okabayashi, Sagamihara (JP); Naoyuki SAWASAKI, Kawasaki (JP)

(73) Assignee: FUJITSU LIMITED, Kawasaki-shi (JP)

(21) Appl. No.: 15/165,428

(22) Filed: May 26, 2016

(30) Foreign Application Priority Data
Jun. 3, 2015 (JP) 2015-113462
Mar. 28, 2016 (JP) 2016-064660

(51) Int. Cl. G06F 17/30

(52) U.S. Cl. CPC G06F 17/30592; G06F 17/30554

(57) ABSTRACT

An apparatus divides a feature value space in which input data points are to be disposed, into a plurality of local regions, and determines a representative point independently for each of one or more local regions each including at least one data point. In a case where a data point is added to a local region in which the representative point is disposed, the apparatus determines a new representative point to which a weight is assigned, based on the added data point and the representative point, and controls the number of clusters by using the new representative point.

### CROSS-REFERENCE TO RELATED APPLICATIONS

This application is based upon and claims the benefit of priority of the prior Japanese Patent Application No. 2015-113462, filed on Jun. 3, 2015, and the prior Japanese Patent Application No. 2016-064660, filed on Mar. 28, 2016, the entire contents of which are incorporated herein by reference.

### FIELD

The embodiments discussed herein are related to apparatus and method for clustering data in streaming clustering without reducing precision.

### BACKGROUND

Clustering processing is an important method that is the basis for artificial intelligence information processing such as image processing, speech recognition, natural language processing, sensor data processing, and DNA sequence mining. The clustering processing is broadly classified into a hierarchical clustering method which is typified by a self-organizing map or Ward's method, and a non-hierarchical clustering method which is typified by a k-means method.

With respect to the hierarchical clustering method, the self-organizing map has a disadvantage in that it is difficult to deal therewith since the convergence of calculation thereof is not obtained, and the Ward's method has a disadvantage in that it is required to calculate a distance between all data points, and in particular, calculation is difficult with respect to large-scale data.

Meanwhile, with respect to the non-hierarchical clustering method, the k-means method has a disadvantage in that it is required to give a cluster number in advance, and application is difficult with respect to an alien environment. In recent years, a DP-means method is proposed that is based on a non-parametric Bayesian method using a probability model and that automatically determines the cluster number according to complexity of data. The method is the non-hierarchical clustering method and has an advantage in that it is possible to dynamically determine the cluster number and the handling thereof is easy unlike the hierarchical clustering method.

Here, a summary of the DP-means method is described with reference to FIG. 34. FIG. 34 is a diagram illustrating the summary of the DP-means method. As indicated in FIG. 34, the DP-means method allocates respective data points to the nearest cluster. Then, if the distance between the data points and the nearest cluster is λ or more, a new cluster is generated. Then, each cluster calculates a center of gravity of allocated data points, and updates the center of gravity of each cluster.

The DP-means method updates the center of gravity of the cluster and the number of clusters is updated such that an objective function value φ (x, λ) which is illustrated below in Formula (1) is optimized.

φ(x,λ)=ΣD(x,u)+λ²k (1)

Here, x indicates a d-dimensional data point group, k indicates the number of clusters, and λ indicates a hyperparameter to determine the number of clusters. D(x, u) is a distance function, and for example, corresponds to a square Euclidean distance which is illustrated below in Formula (2).

D(x,u)=∥u−x∥² (2)

Here, in the DP-means method, when optimization of the objective function value φ(x, λ) is performed, it is required to hold all of the data points in order to use all data points. In addition, in a case where clustering processing is performed with respect to a large number of data points, since an amount of calculation in calculation processing is increased proportionally to the number of data points which are held, the amount of calculation becomes very large. In this manner, a method in which clustering processing is performed in a state in which all data points are held is referred to as “batch clustering”.

In contrast to this, a method in which clustering processing is performed by using representative points extracted from all the data points is referred to as “streaming clustering”.

International Publication Pamphlet No. WO2011/142225, Japanese Laid-open Patent Publication No. 2002-304626, Japanese Laid-open Patent Publication No. 2010-134632, Japanese Laid-open Patent Publication No. 2013-182341 and Japanese Laid-open Patent Publication No. 10-171823 are examples of the related art.

“B. Kulis and M. Jordan, “Revisiting k-means: New Algorithms via Bayesian Nonparametrics”, In ICML2012.” is an example of the related art.

### SUMMARY

According to an aspect of the invention, an apparatus divides a feature value space in which input data points are to be disposed, into a plurality of local regions, and determines a representative point independently for each of one or more local regions each including at least one data point. In a case where a data point is added to a local region in which the representative point is disposed, the apparatus determines a new representative point to which a weight is assigned, based on the added data point and the representative point, and controls a number of clusters by using the new representative point.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a functional configuration of an information processing device, according to an embodiment;

FIG. 2 is a diagram illustrating an example of a grid, according to an embodiment;

FIG. 3 is a diagram illustrating an example of a data structure of a grid list, according to an embodiment;

FIG. 4 is a diagram illustrating an example of a data structure of a representative point list, according to an embodiment;

FIG. 5 is a diagram illustrating an example of representative point update processing, according to an embodiment;

FIG. 6 is a diagram illustrating an example of clustering in which representative point update processing is used, according to an embodiment;

FIG. 7A is a diagram illustrating an example of a grid, according to an embodiment;

FIG. 7B is a diagram illustrating an example of a grid, according to an embodiment;

FIG. 8 is a diagram illustrating an example of a method for determining a maximum number of held points, according to an embodiment;

FIG. 9 is a diagram illustrating an example of an operational flowchart for representative point update processing, according to an embodiment;

FIG. 10 is a diagram illustrating an example of an operational flowchart for representative point compression processing, according to an embodiment;

FIG. 11 is a diagram illustrating an example of an operational flowchart for clustering processing in which representative point update processing is used, according to an embodiment;

FIG. 12 is a diagram illustrating an example of an operational flowchart for clustering processing, according to an embodiment;

FIG. 13 is a diagram illustrating an example of online clustering in which representative point update processing is used, according to an embodiment;

FIG. 14 is a diagram illustrating an example of a case for splitting a representative point, according to an embodiment;

FIG. 15 is a diagram illustrating an example of a functional configuration of an information processing device, according to an embodiment;

FIG. 16 is a diagram illustrating an example of a data structure of a representative point list, according to an embodiment;

FIG. 17 is a diagram illustrating an example of a representative point range, according to an embodiment;

FIG. 18 is a diagram illustrating an example of a condition in which a representative point is split, according to an embodiment;

FIGS. 19A and 19B are diagrams illustrating an example of an operational flowchart for representative point splitting processing, according to an embodiment;

FIG. 20 is a diagram illustrating an example of an operational flowchart for clustering processing, according to an embodiment;

FIG. 21 is a diagram illustrating an example of a functional configuration of an information processing device, according to an embodiment;

FIG. 22 is a diagram illustrating an example of a data structure of a cost function table, according to an embodiment;

FIG. 23 is a diagram illustrating an example of a data structure of a representative point/cluster correspondence table, according to an embodiment;

FIG. 24 is a diagram illustrating an example of a data structure of a cluster center set, according to an embodiment;

FIG. 25 is a diagram illustrating an example of a flow of clustering processing, according to an embodiment;

FIG. 26 is a diagram illustrating an example of a condition under which representative points are integrated, according to an embodiment;

FIG. 27 is a diagram illustrating an example of a premise of derivation of a cost function, according to an embodiment;

FIG. 28 is a diagram illustrating an example of an operational flowchart for clustering processing, according to an embodiment;

FIG. 29 is a schematic diagram illustrating an example of clustering processing, according to an embodiment;

FIG. 30 is a diagram illustrating an example of a flow of clustering processing, according to an embodiment;

FIG. 31 is a diagram illustrating an example of a premise of derivation of a cost function, according to an embodiment;

FIG. 32 is a diagram illustrating an example of an operational flowchart for clustering processing, according to an embodiment;

FIG. 33 is a diagram illustrating an example of a configuration of a computer which executes a data clustering program, according to an embodiment;

FIG. 34 is a schematic diagram illustrating an example of a DP-means method; and

FIG. 35 is a diagram illustrating an example in which clustering precision is reduced in streaming clustering.

### DESCRIPTION OF EMBODIMENTS

In order to perform streaming clustering, it is required to select representative points by using some methods. If the representative points are selected simply at random (called random sampling), there is a problem in that clustering precision is reduced. This is because, in the random sampling, in a case where imbalance is generated in the input data points and there is a cluster with few data points, clustering information is easily lost.

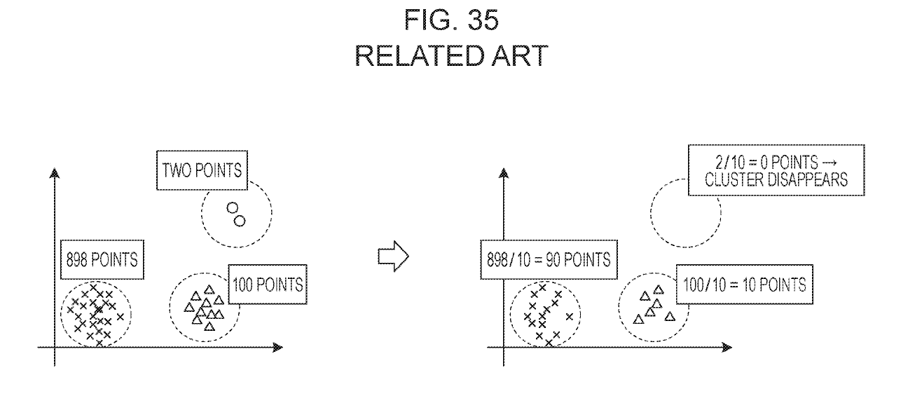

In streaming clustering, an example in which clustering precision is reduced is described with reference to FIG. 35. FIG. 35 is a diagram illustrating the example in which clustering precision is reduced in streaming clustering. In FIG. 35, there is a case where there is imbalance of the data points included in each cluster, and a case is set in which each cluster holds data points of 898 points, 100 points, and two points. Here, a case is set in which 1/10 data points are selected as the representative points in an equal proportion with respect to all clusters. By doing this, in the cluster in which only two data points are included, no point is selected, and the cluster information is lost. Accordingly, the number of clusters is output which is different from a case in which batch clustering is performed, and clustering precision is largely reduced.

It is desirable to suppress precision reduction in streaming clustering.

As embodiments for the present application, applied examples of a data clustering method, an information processing device, and a data clustering program which will be described in detail with reference to the drawings. Here, the present disclosure is not limited to the applied examples.

### Applied Example 1

### Information Processing Device Configuration According to Applied Example 1

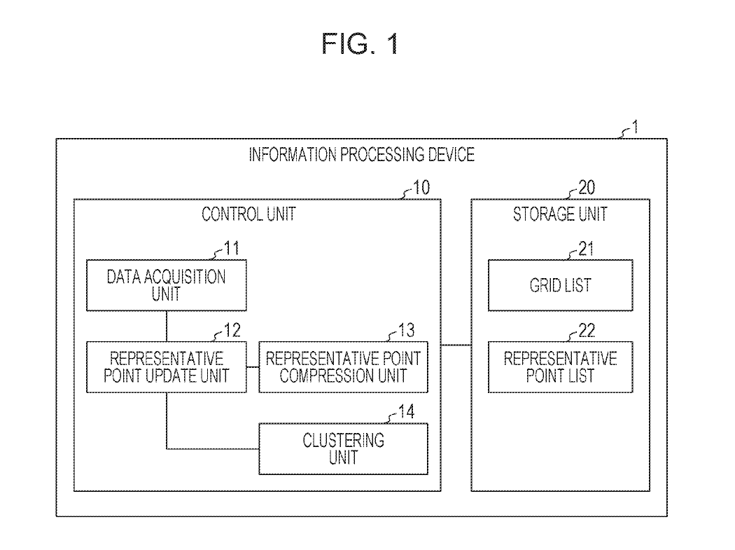

FIG. 1 is a functional block diagram illustrating a configuration of an information processing device according to Applied Example 1. An information processing device 1 which is indicated in FIG. 1 divides a feature value space in which input data points are disposed in a local region (hereinafter also referred to as “grid”), and at least one representative point is held in a grid region in which there exists a data point. The information processing device 1 determines whether or not the number of representative points exceeds a fixed number in each local region, and representative points in the local region in which the number of representative points exceed the fixed number are compressed (thinned out). Thereby, since the information processing device 1 holds at least one point at a location at which each cluster is present, it is possible to inhibit cluster information whose number of points is low, from being lost. Furthermore, in the information processing device 1, since the number of representative points does not exceed the fixed number at the location at which each cluster is present, the number of representative points held is suppressed to the fixed number. As a result, the information processing device 1 is able to perform clustering with good precision, without constantly holding all data points.

The information processing device 1 includes a control unit 10 and a storage unit 20.

The control unit 10 corresponds to an electronic circuit such as a central processing unit (CPU). Then, the control unit 10 has an internal memory in order to store a program and control data which specify various processing, and thereby executes various processing. The control unit 10 includes a data acquisition unit 11, a representative point update unit 12, a representative point compression unit 13, and a clustering unit 14.

For example, the storage unit 20 is a storage device, such as a semiconductor memory element such as a RAM or a flash memory, a hard disk, or an optical disc. The storage unit 20 includes a grid list 21 and a representative point list 22. The grid list 21 indicates grid information which holds the representative points. The representative point list 22 indicates information on representative points which are held in the grid. For example, coordinates and weights of the representative points are included in the information on the representative points. The data structures of the grid list 21 and the representative point list 22 will be described later.

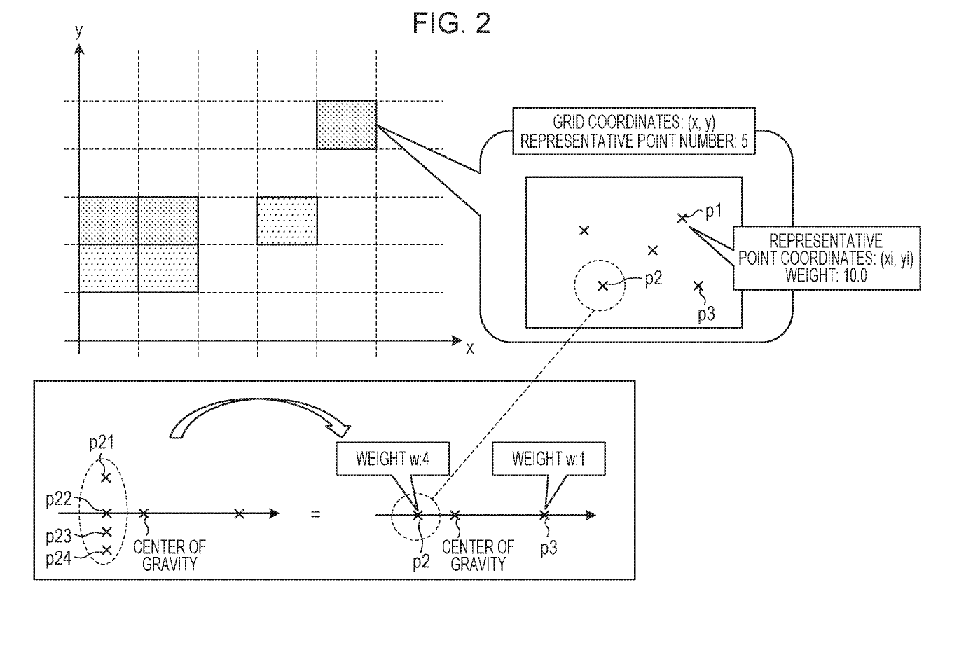

Here, the grid is described referring to FIG. 2. FIG. 2 is a diagram for describing a grid. As indicated in FIG. 2, the grid is a local region obtained by dividing the feature value space in which the input data points are disposed, by a predetermined size. The grid is generated in a portion in which there exists at least one data point. The generated grid is stored in the grid list 21 which will be described later. The representative points are selected from the input data points. The coordinates of a representative point indicates a parameter as a feature value of representative point which are selected from among the input data points. The weight of a representative point indicates a parameter which is incremented when the other data points are merged with the representative point. The coordinates of the representative point and the weight of the representative point are stored in the representative point list 22 which will be described later. As one example, at a representative point p1, coordinates of the representative point is (xi, yi), and the weight of the representative point is 10.0.

The weight of the representative point is a parameter for preventing the center of gravity position from being changed before and after the processing even if representative point compression processing is performed, and is assigned to the representative points information. In an example in FIG. 2, when p21, p22, p23, and p24 are compressed, the parameter which indicates the weight is assigned to a representative point p2 (p22) as information of compressed data point. As an example, the weight is equivalent to the number of data points. Accordingly, here, “4” is assigned as a parameter of weight w to information of the representative point p2. By using the weighting parameter, the center of gravity position after data points are compressed (thinned out) is substantially unchanged and equal to a center of gravity position which uses all the data points.

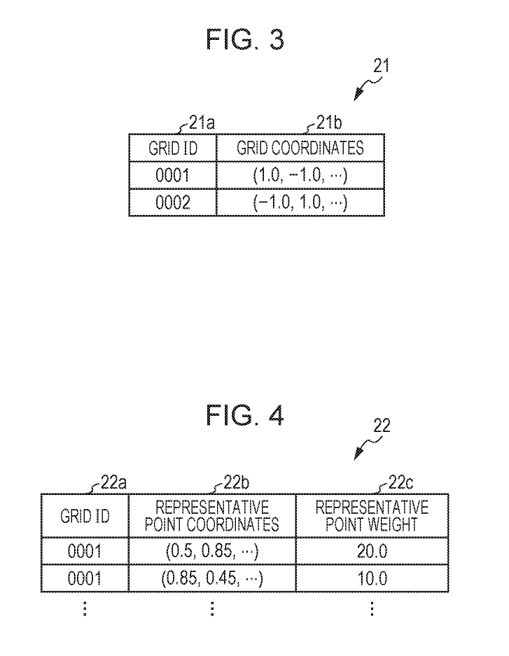

Here, the data structure of the grid list 21 is described with reference to FIG. 3. FIG. 3 is a diagram illustrating an example of the data structure of the grid list. As indicated in FIG. 3, the grid list 21 stores a grid ID 21a and grid coordinates 21b in association with each other. The grid ID (IDentfier) 21a is an identifier which uniquely identifies a grid. The grid coordinates 21b indicate a position (coordinates) of a local region in a feature value space of grids.

The data structure of the representative point list 22 is described with reference to FIG. 4. FIG. 4 is a diagram illustrating an example of the data structure of the representative point list. As indicated in FIG. 4, the representative point list 22 stores representative point coordinates 22b and representative point weight 22c in association with the grid ID 22a. The grid ID 22a is an identifier which uniquely identifies a grid. The representative point coordinates 22b are coordinates of the representative point. The representative point weight 22c is a weight of the representative point.

Returning to FIG. 1, the data acquisition unit 11 acquires data points to be clustered. For example, the data acquisition unit 11 acquires data points which are input from outside. As an example, data points to be clustered are acoustic signals (hereinafter referred to as sound data) which is quantized at 16 kHz and 16 bit, but are not limited to sound data.

The representative point update unit 12 updates representative points such that the number of representative points in the grid does not exceed the fixed number. The fixed number here indicates the number of data points which are able to be held in the grid, hereinafter referred to as “maximum number of held points”. For example, the representative point update unit 12 receives data points which are acquired by the data acquisition unit 11. There may be one or a plurality of received data points. The representative point update unit 12 determines whether there is a grid which includes the coordinates of received data points, among grids registered in the grid list 21. In a case where the representative point update unit 12 determines that there is a grid which includes coordinates of the data points, among grids registered in the grid list 21, the data points are added to the grid. At this time, the representative point update unit 12 sets the data point weight at one. In a case where the representative point update unit 12 determines that there is no grid which includes coordinates of the data points, among grids registered in the grid list 21, a grid is newly generated which includes the coordinates of the data points, and the data points are added to the generated grid. At this time, the representative point update unit 12 sets the data point weight at one, and the newly generated grid is added to the grid list 21. The representative point update unit 12 determines whether or not the number of representative points exceeds the maximum number of held points with respect to the respective grids which are registered in the grid list 21 after the received data points are added to the grid. In the representative point update unit 12, in a case where the number of representative points exceeds the maximum number of held points, representative point compression processing is executed and the representative points are updated such that the number of representative points in the target grid does not exceed the maximum number of held points. Representative point compression processing is executed by the representative point compression unit 13.

In the representative point compression unit 13, in a case where the number of representative points in the grid exceeds the maximum number of held points, the representative points are compressed such that the number of representative points in the grid does not to exceed the maximum number of held points. For example, the representative point compression unit 13 selects a new representative point from among the representative points which are included in the grid. The representative point compression unit 13 selects the closest representative point that is closest to the new representative point, from among the representative points which are included in the grid. The representative point compression unit 13 adds one to the weight of the new representative point, and deletes the closest representative point. That is, the representative point compression unit 13 causes the number of representative points in the grid to finally become the maximum number of representative points or less, by compressing the new representative point and the representative point closest to the new representative point. Here, as a selection method of the new representative point, a method of randomly sampling the representative points included in the grid, or a selection method of the representative points of a case in which the number of clusters is a fixed value, such as the k-means method, may be used. In addition, the maximum number of held points may be a fixed number which is different in each grid, and may be a fixed number which is the same in each grid. An example of a determination method of a maximum number of held points will be described later.

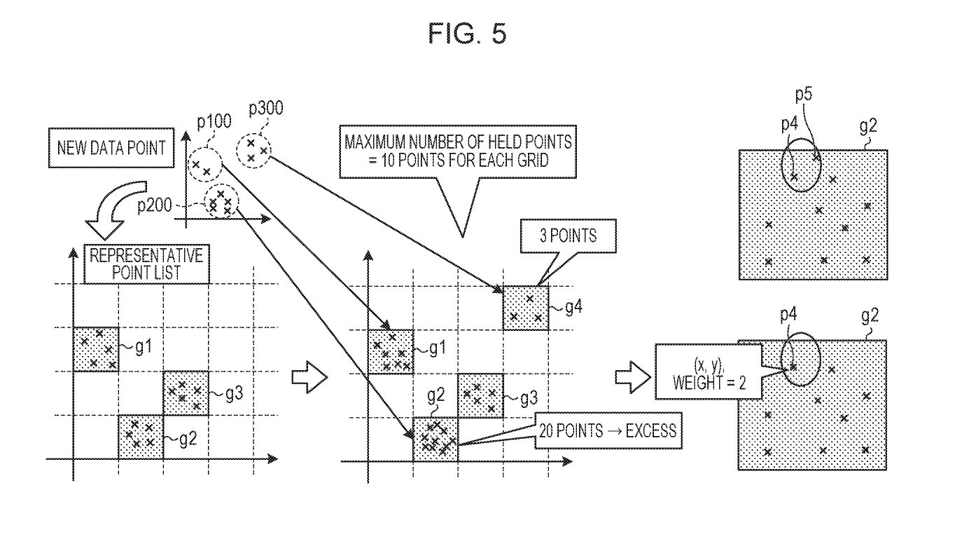

Here, representative point update processing according to the representative point update unit 12 is described with reference to FIG. 5. FIG. 5 is a diagram illustrating representative point update processing according to Applied Example 1. As indicated in FIG. 5, the representative point update unit 12 combines (merges) new data points with the grid of the representative point which is registered in the representative point list 22. The representative point update unit 12 generates a new grid when a new data point is inserted in a portion which is not in the grid.

That is, when a grid including the coordinates of a new data point is registered in the grid list 21, the representative point update unit 12 adds a new data point to the grid. When a grid including the coordinates of a new data point is not registered in the grid list 21, the representative point update unit 12 generates a new grid, and adds the new data point to the newly generated grid. Here, a new data point group of a reference numeral p100 is merged in a grid g1, a new data group of a reference numeral p200 is merged in a grid g2, and a new data point group of a reference numeral p300 is added to a newly generated grid g4.

Then, the representative point update unit 12 determines whether or not the number of representative points exceeds the maximum number of held points with respect to the respective grids after the new data points are merged in the grid, and selects the grid in which the maximum number of held points is exceeded. Here, the maximum number of held points is set at a fixed number of ten points which is the same in each grid. In grids g1, g3, and g4, it is determined that the maximum number of held points 10 is not exceeded. In grid g2, there are 20 points, and it is determined that the maximum number of held points 10 is exceeded. As a result, the grid g2 is selected as a grid in which the maximum number of held points is exceeded.

Then, the representative point compression unit 13 selects a representative point in a grid in which the maximum number of representative points is exceeded, and compresses the selected representative point and a representative point closest to the selected representative point. The representative point compression unit 13 adds one to the weight of the selected representative point, and deletes the closest representative point. The representative point compression unit 13 repeats compression processing until the number of representative points within the grid becomes the maximum number of representative points. In this case, the representative point compression unit 13 selects the representative point p4 within the grid g2, and compresses the selected representative point p4 and the representative point p5 closest to the representative point p4. The representative point compression unit 13 adds one the weight of the representative point p4, and deletes the representative point p5. As a result, the weight of the representative point p4 becomes two.

Returning to FIG. 1, the clustering unit 14 executes batch clustering processing by inputting representative points which are included in a grid registered in the grid list 21. For example, the clustering unit 14 acquires the representative points which are included in the grid registered in the grid list 21 from the representative point list 22, and executes the DP-means method by inputting the acquired representative points. Since the DP-means method uses the representative points in which a weighting is applied, here the DP-means method is referred to as a “weighted DP-means method”. Here, the clustering unit 14 applies the DP-means method as the clustering method, but he clustering method is not limited to the DP-means method, and a clustering method in which the clustering number varies is also available. For example, as the hard clustering method, a clustering method in which a cluster number indicating the number of clusters is fixed, such as the K-means method, is applied to a plurality of cluster numbers, and a method of adopting one of the plurality of cluster numbers as a result is available. In addition, an HDP-means method which assumes a hierarchical relationship of clusters is able to be applied. As a stochastic soft clustering method, a Dirichlet process mixture (DPM), a hierarchical Dirichlet process (HDP), and a nested Dirichlet process (NDP) are able to be applied.

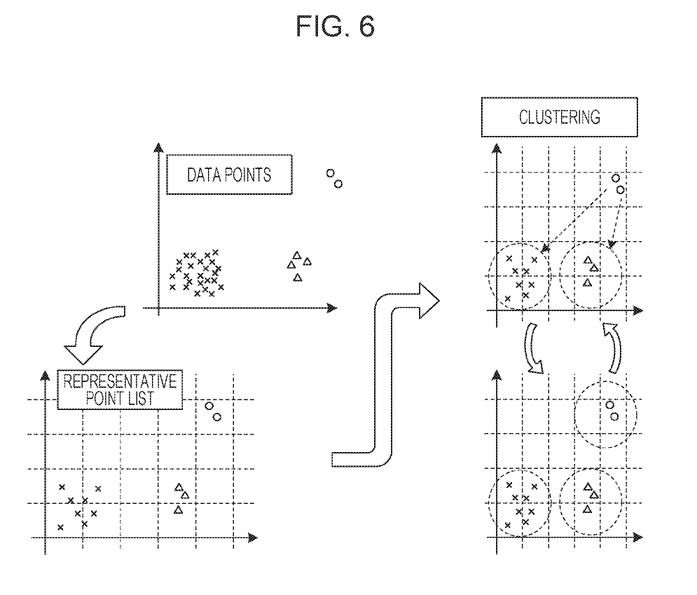

Here, clustering processing according to the clustering unit 14 is described with reference to FIG. 6. FIG. 6 is a diagram describing clustering processing according to Applied Example 1. First, as indicated in FIG. 6, the representative point update unit 12 updates the representative points by acquiring a portion of the data points, and repeats a process for updating the representative points by acquiring a portion of the data points again. Then, the clustering unit 14 performs batch clustering processing with respect to the finally updated representative points. The clustering unit 14 substitutes the center of gravity for each of all the representative points, into a cluster center set. For each representative point, the clustering unit 14 extracts a center whose distance from the each representative point is closest to the center within the cluster center set. Here, for example, the “distance” described here refers to Euclidean distance. When the distance between the each representative point and the extracted center is smaller than a threshold λ (a parameter which determines a cluster particle size), the clustering unit 14 allocates the each representative point to a cluster having the extracted center. When the distance between the each representative point and the extracted center is the threshold λ or more, the clustering unit 14 adds the each representative point to the cluster center set as a new cluster center. Thereafter, the clustering unit 14 extracts a cluster center from the cluster center set, and updates the coordinate values of the extracted cluster center to a center of gravity value to which the weight of the representative point is assigned.

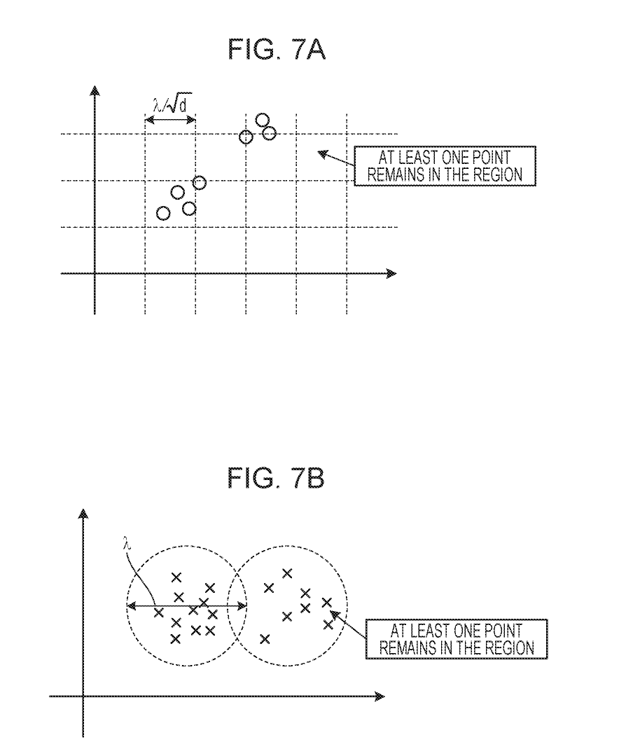

Here, an example of the grid is described with reference to FIG. 7A. FIG. 7A is a diagram illustrating an example of the grid. The example of the grid which is indicated in FIG. 7A is a d-dimensional hypercube in the feature value space. That is, in a case of two dimensions, the grid is a square shape, in a case of three dimensions, the grid is cubic, and in the case of four dimensions, the grid is a tesseract. In a case where λ is a parameter which determines the cluster particle size, for example, the diameter of the cluster, it is desirable that a length of a side of the grid is λ/\sqrt{d} or less. As a precondition, it is assumed that a new cluster is generated when the distance between data points is λ or more. In the case, when the length of a side of a grid is λ/\sqrt{d} or less, the distance between any pair of data points included in the same grid is assured to be λ or less. That is, a distance between two points among points within the grid becomes a maximum value when the two points are positioned on a diagonal line of the grid, and the length of the diagonal line at this time is (the length of the side λ/\sqrt{d}×\sqrt{d}=)λ. Accordingly, since a distance between any two data points included in one grid is λ or less, the two data points are included in one cluster but are not included in another cluster. As a result, even if the representative point compression unit 13 performs representative point compression processing on the respective grids, it is assured that the cluster will not disappear due to the clustering process. That is, when the length of a side of a grid is λ/\sqrt{d} or less, and when at least one of the data points remains in the grid, the cluster does not disappear.

Another example of a grid is described with reference to FIG. 7B. FIG. 7B is a diagram illustrating another example of a grid. The example of a grid which is indicated in FIG. 7B is a d-dimensional hypersphere in the feature value space. When λ is a parameter which determines the cluster particle size, for example, the diameter of the cluster, it is desirable that the diameter is λ or less. As a precondition, it is assumed that a new cluster is generated when the distance between data points is λ or more. In the case, when the diameter of the grid is λ or less, the distance between any pair of data points included in the same grid is assured to be λ or less. That is, a distance between two points among points within a grid becomes a maximum value when the two points are positioned on a diameter of the grid, and the length of the diameter at this time is λ. Accordingly, since a distance between any two data points included in one grid is λ or less, the two data points are included in one cluster but are not included in another cluster. As a result, even if the representative point compression unit 13 performs representative point compression processing on the respective grids, it is assured that the cluster will not disappear due to the clustering process. That is, when the diameter of a grid is λ or less, and when at least one of the data points remains in the grid, the cluster does not disappear.

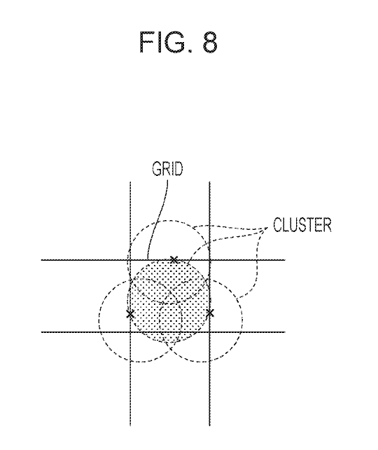

Next, an example of a determination method of a maximum number of held points is described with reference to FIG. 8. FIG. 8 is a diagram illustrating an example of the determination method of the maximum number of held points. The maximum number of held points for each grid is able to be determined as an arbitrary number. However, it is desirable to set the maximum number of held points at two when a dimension number d indicating the number of dimensions in the feature value space is one, and it is desirable to set the maximum number of held points at d (dimension number) when the dimension number d is two or more. As indicated in FIG. 8, when there are two dimensions or more, it is assured that the maximum number of cluster centers included in the grid is less than the dimension number d+1. However, in the case of one dimension, the maximum number of cluster centers included in the grid is two or less, that is, dimension number d+1 or less. As described below, it is possible to recursively indicate this. First, in a case where the dimension number d is one, it is obvious that a case where cluster centers are positioned on a number line with being separated by d is optimal. As for a case where the dimension number d is two or more, it is assumed that, under the hypothesis that the number of cluster centers included in a grid is less than d+1 in the case of d dimensions, there is a case where d+2 or more cluster centers are included in a grid in the case of d+1 dimensions. According to this assumption, there exists a subspace in which d+1 or more cluster centers are included in a grid, which is inconsistent with the above hypothesis. Accordingly, it is desirable to hold representative points whose number is equal to the number of dimensions in each grid.

In other words, as indicated in FIG. 8, in the case of two dimensions, it is possible to dispose clusters, for which three vertices of an equilateral triangle are set as cluster centers, in one grid. In this case, the cluster overlaps. Accordingly, so as not to overlap clusters in a grid, it is desirable for the number of cluster centers included in a grid to be less than three, that is, two or less. The same applies to two dimensions or more. Accordingly, in the case of two dimensions or more, when only the representative points whose number is the dimension number d remain as a maximum number of held points in a grid, it is assured that the cluster does not disappear even if representative point compression processing is performed. As a result, it is possible to keep the precision of the clustering process.

Here, furthermore, as indicated above, since d is sufficient for the maximum number of representative points to be held within a grid, it is possible to keep the precision of the cluster center of gravity by performing clustering processing under the assumption that there are d fixed clusters within a grid. For example, since a method is known in which an error of the center of gravity position of the cluster is suppressed to a constant factor in a case where the cluster number is fixed, such as a k-means method, the k-means method may be used as a compression algorithm, and when compression processing is performed with the cluster number d, it is possible to perform clustering processing with good precision. At this time, in the k-means method, the maximum number of held points of the held representative points may be 3d×log(d).

Representative Point Update Processing Flow Chart

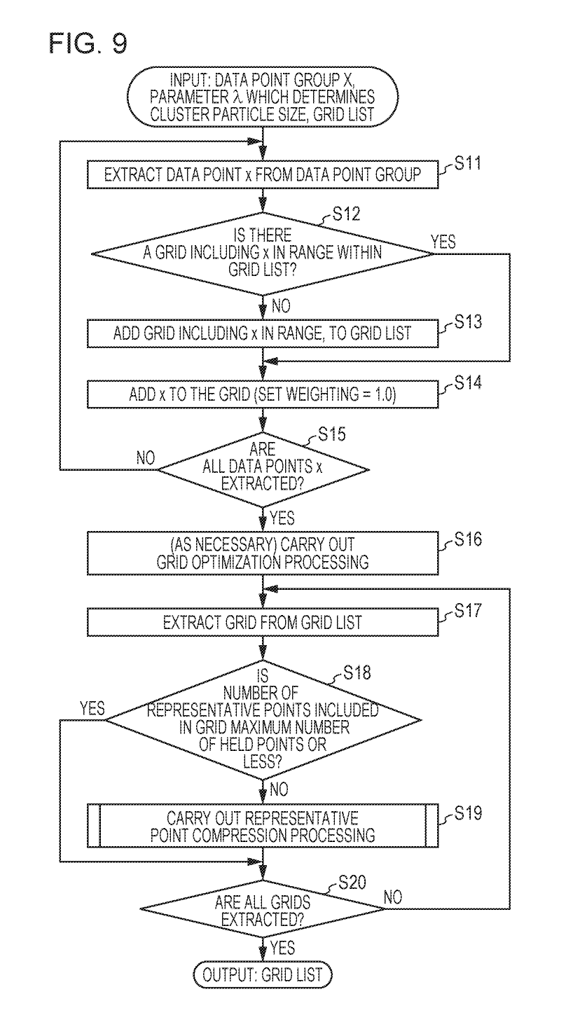

Next, an operational flowchart for representative point update processing according to Applied Example 1 is described with reference to FIG. 9. FIG. 9 is a diagram illustrating an operational flowchart for representative point update processing according to Applied Example 1. Here, the representative point update unit 12 acquires the parameter λ in which a data point group X and cluster particle size are determined and the grid list 21, as input parameters. In the case, the data point group X is not limited to all of the data which uses final clustering processing, and there may be a portion of the data which is used in final clustering processing.

First, the representative point update unit 12 removes data points x from the data point group X (step S11). The representative point update unit 12 determines whether or not there is a grid which includes data points x in a range thereof, within the grid list 21 (step S12). In a case where it is determined that there is no grid which includes data points x in the range thereof (step S12: No), the representative point update unit 12 generates a new grid which includes data points x in the range thereof, and adds grid coordinates 21b of the generated grid to the grid list 21 (step S13). Then, the representative point update unit 12 transitions to step S14.

Meanwhile, in a case where it is determined that there is a grid which includes the data points x in the region thereof (step S12: Yes), the representative point update unit 12 adds the data point x whose weight is set at 1.0, to the grid (step S14). The representative point update unit 12 determines whether or not data all the data points x are extracted from the data point group X (step S15). In a case where it is determined that not all the data points x are extracted (step S15: No), the representative point update unit 12 transitions to step S11 so as to extract the subsequent data points.

Meanwhile, in a case where it is determined that all the data points x are extracted (step S15: Yes), the representative point update unit 12 performs, if necessary, optimization processing on the grids (step S16). When the representative point update unit 12 generates a grid, there is a case where the center of the grid is not optimal. In this case, too many grids may be held, and there is a possibility that an unnecessary storage region is required.

Subsequently, the representative point update unit 12 extracts a grid from the grid list 21 (step S17). The representative point update unit 12 determines whether or not the number of representative points included in the grid is the maximum number of held points or less (step S18). In a case where it is determined that the number of representative points included in the grid is the maximum number of held points or less (step S18: Yes), the representative point update unit 12 transitions to step S20 without executing representative point compression processing.

In a case where the number of representative points included in the grid is not the maximum number of held points or less, that is, is greater than the maximum number of held points (step S18: No), the representative point update unit 12 executes representative point compression processing (step S19). The operational flowchart for representative point compression processing will be described later. Then, the representative point update unit 12 transitions to step S20.

In step S20, the representative point update unit 12 determines whether or not all the grids are extracted from the grid list 21 (step S20). In a case where it is determined that not all the grids are extracted (step S20: No), the representative point update unit 12 transitions to step S17 so as to extract the subsequent grids.

Meanwhile, in a case where it is determined that all the grids are extracted (step S20: Yes), the representative point update unit 12 ends representative point update processing, and outputs the grid list 21 as an output parameter.

Representative Point Compression Processing Flow Chart

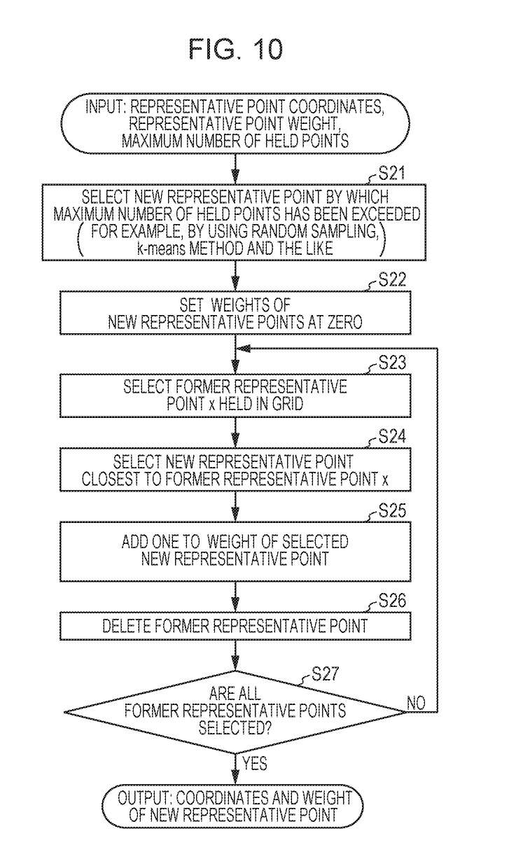

Next, an operational flowchart for representative point compression processing according to Applied Example 1 is described with reference to FIG. 10. FIG. 10 is a diagram illustrating an operational flowchart for representative point compression processing according to Applied Example 1. Here, as the input parameter, the representative point compression unit 13 acquires coordinates of representative points included in a grid which has been determined to include data points whose number is larger than the maximum number of held points, weights of the representative points, and the maximum number of held points.

The representative point compression unit 13 selects a new representative point by which the maximum number of held points has been exceeded, from among the representative points which are acquired as the input parameter (step S21). For example, random sampling, the k-means method, and the like are given as a new representative point selection method. Then, the representative point compression unit 13 set the weights of new representative points at zero (step S22).

Subsequently, the representative point compression unit 13 sequentially selects a former representative point x which is held in a grid (step S23). The representative point compression unit 13 selects a new representative point that is closest to the selected former representative point x (step S24). The representative point compression unit 13 adds one to the weight of the selected new representative point (step S25). Then, the representative point compression unit 13 deletes the selected former representative point x from the representative point list 22 (step S26).

Subsequently, the representative point compression unit 13 determines whether or not all the former representative points are selected (step S27). In a case where it is determined that not all the former representative points are selected (step S27: No), the representative point compression unit 13 transitions to step S23 so as to select a subsequent former representative point. Meanwhile, in a case where it is determined that all the former representative points are selected (step S27: Yes), the representative point compression unit 13 ends the representative point compression processing, and outputs the coordinates and weight of the new representative points as output parameters.

Clustering Processing Flow Chart

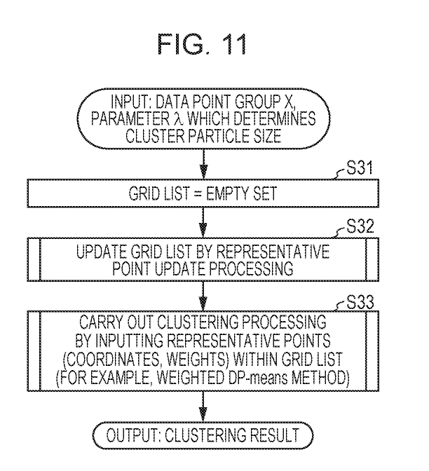

FIG. 11 is a diagram illustrating an operational flowchart for clustering processing in which representative point update processing is used according to Applied Example 1. Here, the information processing device 1 acquires the parameter λ which determines the data point group X and the cluster particle size as input parameters.

First, the information processing device 1 sets the grid list 21 at an empty set (step S31). Then, the information processing device 1 updates the grid list 21 by using representative point update processing (step S32). Here, the flow chart of representative point update processing is indicated in FIG. 9.

Then, the information processing device 1 executes clustering processing by inputting representative points (coordinates, weights) within the grid list 21 (step S33). For example, the weighted DP-means method is applied as clustering processing. Here, an operational flowchart of the clustering processing will be described later.

Then, the information processing device 1 ends clustering processing which uses representative point update processing, and outputs the clustering results as output parameters.

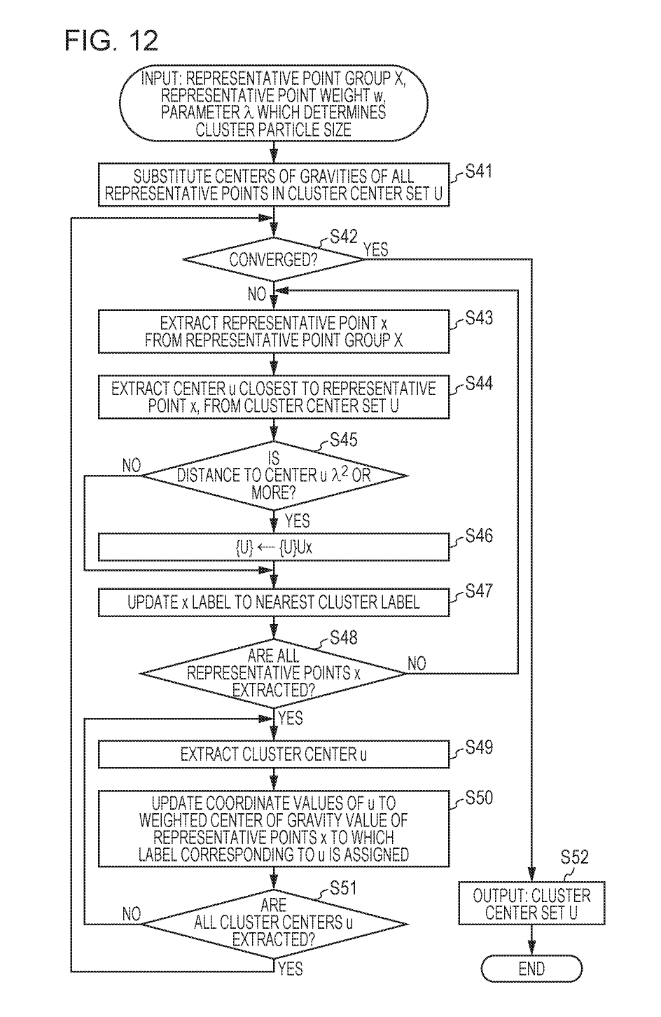

FIG. 12 is a diagram illustrating an operational flowchart for clustering processing according to Applied Example 1. Here, in FIG. 12, a case is described where the weighted DP-means method is applied, and a square Euclidean distance is used as a distance function used when cluster addition is determined. The clustering unit 14 acquires the parameter λ which determines representative point group X, weight w of a representative point, and a cluster particle size, as input parameters.

The clustering unit 14 sets centers of gravities of all representative points as a cluster center set U (step S41). The clustering unit 14 determines whether or not the clustering processing has converged (step S42). In a case where the clustering processing has not converged yet (step S42: No), the clustering unit 14 extracts a representative point x from the representative point group X (step S43). Then, the clustering unit 14 extracts, from the cluster center set U, a center u which is closest to the extracted representative point x (step S44).

Clustering unit 14 determines whether or not the distance between the representative point x and the center u is λ² or more (step S45). In a case where it is determined that the distance between the representative point x and the center u is λ² or more (step S45: Yes), the clustering unit 14 adds the representative point x to the cluster center set U (step S46). Then, the clustering unit 14 transitions to step S47.

Meanwhile, in a case where it is determined that the distance between the representative point x and the center u is not λ² or more, that is, smaller than λ² (step S45: No), the clustering unit 14 transitions to step S47. In step S47, the clustering unit 14 updates the label of the representative points x to the nearest cluster label (step S47).

Subsequently, the clustering unit 14 determines whether or not all the representative points x are extracted from the representative point group (step S48). In a case where it is determined that not all the representative points x are extracted (step S48: No), the clustering unit 14 transitions to step S43 so as to extract subsequent representative points.

Meanwhile, in a case where it is determined that all the representative points x are extracted (step S48: Yes), the clustering unit 14 extracts the cluster center u from the cluster center set U (step S49). The clustering unit 14 updates coordinate values of the extracted u to weighted center of gravity value of the representative point to which a label corresponding to u is assigned (step S50).

Then, the clustering unit 14 determines whether or not all the cluster centers u are extracted from the cluster center set U (step S51). In a case where it is determined that not all the cluster centers u are extracted (step S51: No), the clustering unit 14 transitions to step S49 so as to extract the subsequent cluster center. Meanwhile, in a case where it is determined that all the cluster centers u are extracted (step S51: Yes), the clustering unit 14 transitions to step S42 so as to carry out determination for convergence of the clustering processing.

In step S42, in a case where it is determined that that the clustering processing has converged (step S42: Yes), the clustering unit 14 outputs the cluster center set U (step S52), and the clustering processing ends.

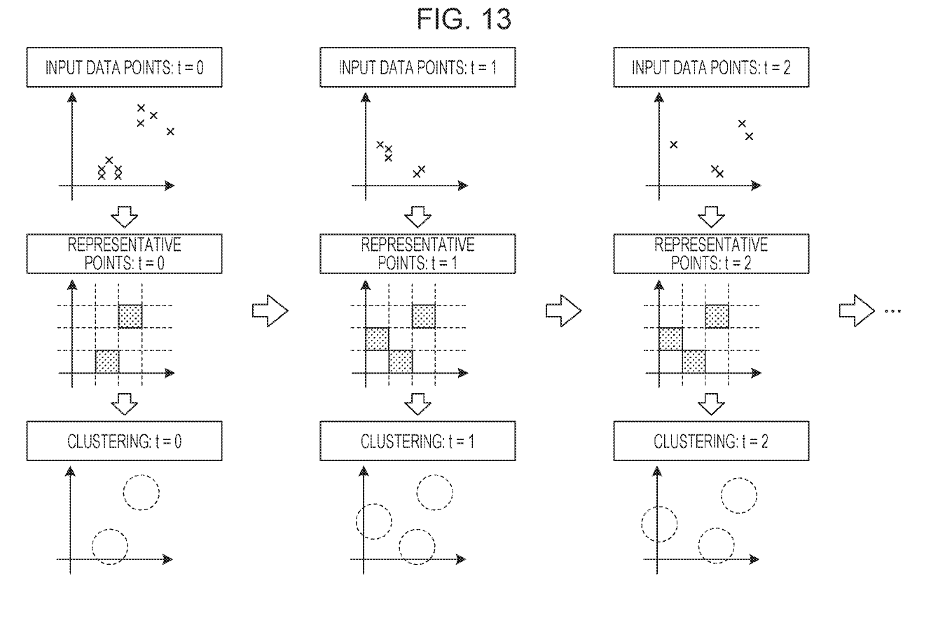

Here, when the information processing device 1 performs clustering processing independently in each fixed period by using the representative points which are updated due to the representative point update processing according to Applied Example 1, it is possible to perform online clustering processing. Online clustering in which the representative point update processing is used according to Applied Example 1 is described with reference to FIG. 13. FIG. 13 is a diagram illustrating online clustering in which representative point update processing according to Applied Example 1 is used.

As indicated in FIG. 13, when a time point t is zero, the information processing device 1 receives input data points. The information processing device 1 performs representative point update processing on the received input data points. That is, when there already exists a grid which includes the input data points in the range, the information processing device 1 adds the input data points to the grid as representative points. When there exist no grids which include the input data points in the range, the information processing device 1 generates a new grid, and adds the input data points to the newly generated grid as representative points. The information processing device 1 performs representative point compression processing and updates the representative points such that the number of representative points in each grid does not exceed the maximum number of held points. Then, the information processing device 1 performs batch clustering processing by inputting the updated representative points.

When time elapses, and a time point t is one, the information processing device 1 receives input data points. The information processing device 1 performs representative point update processing on the received input data points and the representative points which were updated when the time point t was zero. That is, when there already exists a grid which includes the input data points in the range, the information processing device 1 adds the input data points to the grid as representative points. When there exist no grids which include the input data points in the range, the information processing device 1 generates a new grid, and adds the input data points to the newly generated grid as representative points. The information processing device performs representative point compression processing and updates the representative points such that the number of representative points in each grid does not exceed the maximum number of held points. Then, the information processing device 1 performs batch clustering processing by inputting the updated representative points.

When time elapses, and a time point t is two, the information processing device 1 receives input data points. The information processing device 1 performs representative point update processing on the received input data points and the representative points which were updated when the time point t was one. That is, when there already exists a grid which includes the input data points in the range, the information processing device 1 adds the input data points to the grid as representative points. When there exist no grids which include the input data points in the range, the information processing device 1 generates a new grid, and adds the input data points to the newly generated grid as representative points. The information processing device performs representative point compression processing and updates the representative points such that the number of representative points in each grid does not exceed the maximum number of held points. Then, the information processing device 1 performs batch clustering processing by inputting the updated representative points.

In this manner, the information processing device 1 is able to perform online clustering processing by performing clustering processing, independently at each time point, on data points which are input by time division.

### Applied Example 1 Effects

According to Applied Example 1, the information processing device 1 performs steaming clustering as below. That is, the information processing device 1 divides a feature value space in which input data points are disposed into grids. In a case where the information processing device 1 independently determines a representative point with respect to a grid including one or more data points. Thereafter, when data points are added to the grid in which a representative point is present, the information processing device 1 determines a new representative point by performing weighting based on the representative point and the added data points. Then, the information processing device 1 controls the number of clusters by using the new representative point. This allows the information processing device 1 to suppress reduction of clustering precision in streaming clustering. That is, in comparison to a case where the number of data points is randomly reduced, the information processing device 1 determines a weighted representative point as a representation of input data points, and is able to suppress reduction of clustering precision by performing clustering.

In addition, according to Applied Example 1, the information processing device 1 divides a feature value space into grids, each of which is a d-dimensional hypercube whose side length is λ/\sqrt{d}, where λ is a threshold determining the cluster particle size, d is a number of dimensions of the feature value space. In this case, since the length of the diagonal line of the d-dimensional hypercube (the threshold which determines the cluster particle size) is λ, when at least one data point is included in a grid, the cluster therefore does not disappear. As a result, it is possible to avoid a case where a cluster disappears and errors of the number of clusters increases, which is caused by the information processing device 1 randomly determining the representative points.

In addition, according to the Applied Example 1, the information processing device 1 divides a feature value space into grids, each of which is a d-dimensional hypersphere whose diameter is a threshold λ determining a cluster particle size, where d is the number of dimensions of the feature value space. In this case, since the length of the diameter of the d-dimensional hypersphere is λ (the threshold which determines the cluster particle size), when at least one data point is included in a grid, it is assured that the cluster therefore does not disappear. As a result, it is possible to avoid a case where a cluster disappears and errors of the number of clusters increases, which is caused by the information processing device 1 randomly determining the representative points.

In addition, according to Applied Example 1, the information processing device 1 sets the maximum number of held points which are held in a grid, at the dimension number d. In this case, if only the dimension number d of representative points, as a maximum number of held points, remain in a grid, a representative point remains in the grid even if representative point compression processing is performed, thereby assuring that no clusters disappear. As a result, it is possible to avoid a case where a cluster disappears and errors of the number of clusters increases, which is caused by the information processing device 1 randomly determining the representative points.

In addition, according to Applied Example 1, for data points which have been time divided, the information processing device 1 determines a new representative point, based on the representative points that have been already determined and the data points which have been time divided. This allows the information processing device 1 to perform online clustering processing in which representative point update processing is used, and to suppress reduction of online clustering precision.

In addition, according to Applied Example 1, the information processing device 1 sets the maximum number of held points which are held in a grid, at 3×d×log(d). This allows the information processing device 1 to perform clustering processing with good precision, by setting the maximum number of held points of the representative points, which are held using the k-means method, at 3×d×log (d).

### Applied Example 2

As for the information processing device 1 in Applied Example 1, description has been given of a case where a new cluster is generated when the distance between representative points are separated by λ or more. However, the information processing device 1 is not limited thereto, and in a case of falling into a local solution, a cluster may be partitioned by splitting a representative point. The local solution refers to a state in which it is difficult to reach an optimal solution.

Case of Splitting Representative Point

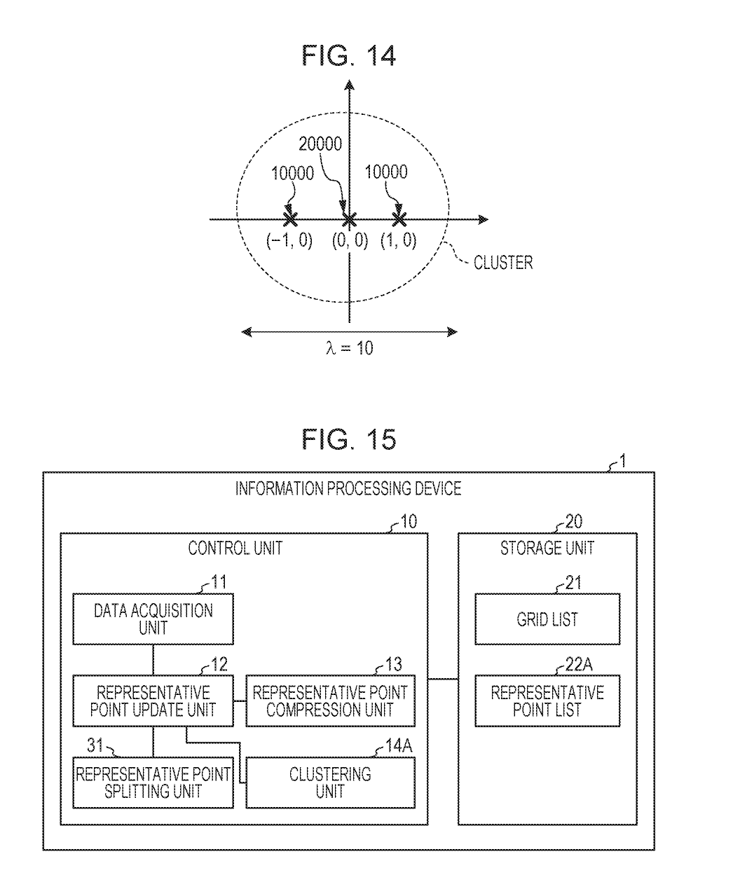

Here, the case of splitting a representative point is described with reference to FIG. 14. FIG. 14 is a diagram illustrating a case in which a representative point is split. First, the DP-means method updates cluster centers of gravity, and updates the number of clusters such that an objective function value is a minimal value. Here the objective function is represented in Formula (3) below.

$$L ( x , c ) = {\sum }_{x ∈ X \{ u ∈ C \}} min {‖ x - u ‖}^{2} + {λ}^{2} k \qquad ( 3 )$$

Here, x is a data point which belongs to data point group X of d dimensions which are input, u is a cluster center which belongs to a cluster center set C, k is the number of clusters, and λ is a parameter which determines a cluster particle size. In FIG. 14, it is assumed that λ is a cluster diameter.

Here, as a distance function which is represented by the cluster center u and the data points x, a square Euclidean distance is used, but the distance function is not limited thereto. For example, the distance function may be one that satisfies symmetry, such as a Manhattan distance or an L∞ distance, and may be one that does not satisfy symmetry, such as of KL divergence, a Mahalanobis distance, or an Itakura Saito distance.

As indicated in FIG. 14, in the case of one cluster, since the cluster center u is (0, 0), the distance between the input data points (−1, 0) and the cluster center u is one, and the distance of the input data point (1, 0) from the cluster center u is one. The weight of the input data points (−1, 0) is 10000, and the weight of the input data points (1, 0) is 10000. Therefore, a value of an objective function L(X, C)(=20000×1²+10²×1) becomes 20100.

In contrast, in the case of two clusters, the cluster centers u are (−1, 0), and (1, 0). Since (−1, 0), and (1, 0), which are set as the input data points, are respectively allocated to the nearest cluster label, the distance between the input data point (−1, 0) and the cluster center u is zero, and the distance between the input data point (1, 0) and the cluster center u is zero. Therefore, a value of an objective function L(X, C) (=20000×0²+10²×2) becomes 200. In the case of two clusters, the objective function value is smaller than that in the case of one cluster. In other words, in the case of one cluster, the objective function does not reach the minimum value, and falls into a local solution.

Consider the case when the weight of the input data points (−1, 0) is 10, and the weight of the input data points (1, 0) is 10. In the case of one cluster, a value of an objective function L(X, C) (=20×1²+10²×1) is 120. In contrast, in the case of two clusters, a value of an objective function L(X, C) (=200×0²+10²×2) is 200. In the case of one cluster, the objective function value is smaller than that in the case of two clusters. An optimal solution is obtained in the case of one cluster. That is, there is a case of falling into a local solution when the weight of a representative point included in a cluster increases. In that case, it is preferable to split the cluster.

In Applied Example 2, a case is described where, in the clustering using weighted representative points, the information processing device 1 splits a representative point when the weight of the representative point increases.

Information Processing Device Configuration According to Applied Example 2

FIG. 15 is a functional block diagram illustrating a configuration of an information processing device according to Applied Example 2. Here, concerning the same configuration to the information processing device 1 which is indicated in FIG. 1, by indicating the same reference numerals, the overlapping configuration and description of the operation are omitted. A difference between Applied Example 1 and Applied Example 2 is a point in which a representative point splitting unit 31 is added. In addition, a difference between Applied Example 1 and Applied Example 2 is a point in which the clustering unit 14 is modified to a clustering unit 14A. Furthermore, a difference between Applied Example 1 and Applied Example 2 is a point in which the representative points list 22 is modified to a representative point list 22A.

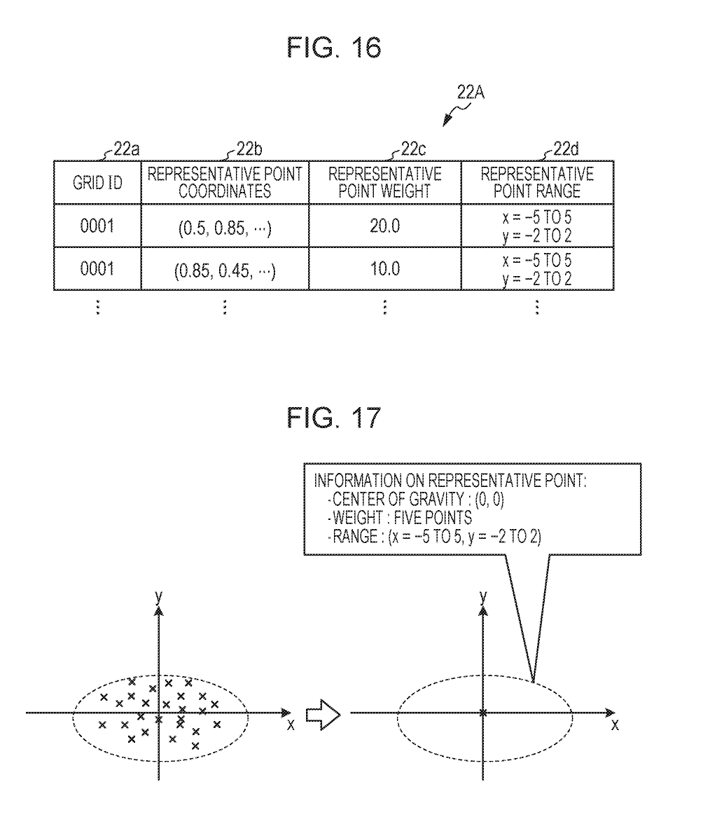

The data structure of the representative point list 22A is described with reference to FIG. 16. FIG. 16 is a diagram illustrating an example of the data structure of the representative point list. As indicated in FIG. 16, the representative point list 22A stores representative point coordinates 22b, representative point weight 22c, and a representative point range 22d in association with the grid ID 22a. The grid ID 22a is identification information identifying a grid. The representative point coordinates 22b are coordinates of a representative point. The representative point weight 22c is a weight of the representative point. The representative point range 22d indicates a range of data points belonging to the representative point. The representative point range 22d may be a maximum value/minimum value of dimensions of the representative point, and may be a dispersed value. Hereinafter, the representative point range 22d is described as a maximum value/minimum value of dimensions of the representative point.

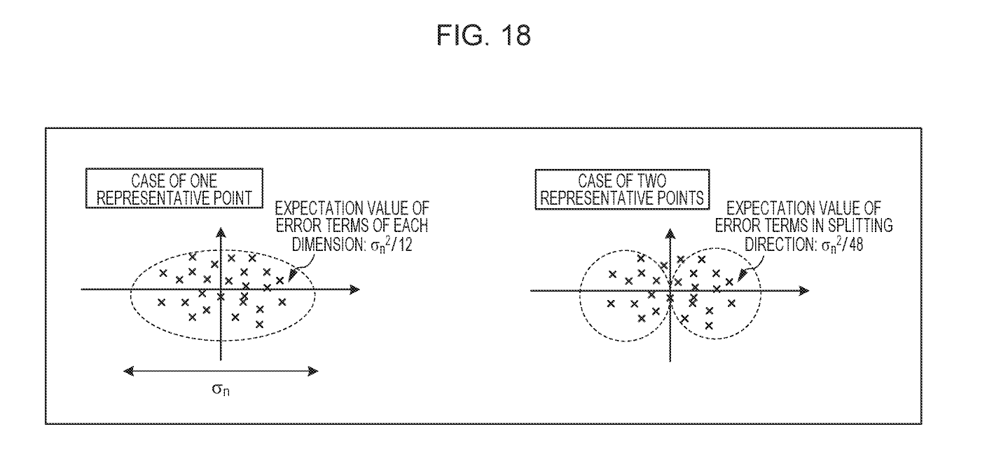

Here, the representative point range 22d is described with reference to FIG. 17. FIG. 17 is a diagram describing a representative point range according to Applied Example 2. As indicated in FIG. 17, when a representative point is selected from data points, for the representative point, a range of a plurality of data points (representative points range) belonging to the representative point is added to the representative point list 22A, in addition to the coordinates and a weight. Here, as an example, for the representative point, the center is set at (0, 0), the weight is set at five, the range is set at −5 to 5 in an x axis direction and −2 to 2 in a y axis direction. That is, the representative point represents data points of −5 to 5 in the x axis direction and −2 to 2 in the y axis direction. Here, the representative point is added to the representative point list 22A by the representative point splitting unit 31 which will be described later.

Returning to FIG. 15, in the representative point splitting unit 31, in a case where the range in dimension n satisfies a condition of Formula (4) below with respect to a representative point having a weight of w, the representative point is split into two in dimension n.

w≧16(λ/σₙ)² (4)
, where w is a weight, λ is a parameter which determines a cluster particle size, σₙ is a range in n dimensions, and σₙ=pₙ−qₙ (pₙ, qₙ: maximum value and minimum value in dimension n).

Formula (4) is used as a condition under which the representative point is split, on the grounds that, when the formula (4) is satisfied, an expectation value of the objective function after splitting becomes smaller than before splitting. Here, a condition for splitting a representative point is described with reference to FIG. 18. FIG. 18 is a diagram illustrating a condition in which a representative point is split.

As indicated in FIG. 18, a left-side diagram indicates a state before the representative point is split, and a case where the number of representative points is one. In this case, under the assumption that data points included in clusters are disposed with a uniform distribution, the expectation value of error terms of each dimension is σₙ²/12. Error terms here indicate a portion of terms Σmin(x−u)² of the objective function which is indicated in Formula (18). The expectation value of error terms is obtained by the formula of the expectation value of the uniform distribution below.

V(x)=(b−a)²/12
, where a is a lower limit, and b is an upper limit.

A right-side diagram of FIG. 18 indicates a state after the representative point is split, and a case where the number of representative points is two. In this case, under the assumption that data points included in clusters are disposed with a uniform distribution and the formula for an expectation value of the uniform distribution is used, the expectation value of error terms in a splitting direction is σₙ²/48(=(σₙ/2)²/12). The above Formula (4), which is equal to a condition in which an expectation value of error terms for the case of two representative points is smaller than an expectation value in the case of one representative point, is obtained from Formula (5) below.

w(σ₁²/12+ . . . +σₙ²/12+ . . . )+λ²≧w(σ₁²/12+ . . . +σₙ2/48+ . . . )+2λ² (5)

Here, in Formula (5), the expectation values of error terms of respective dimensions are added.

Here, Formula (5) above is represented by Formula (32) below.

w (an expectation value of distance between a data point belonging to the representative point before splitting and the representative point)≧w₁ (an expectation value of distance between the data points belonging to representative point 1 after splitting and representative point 1)+w₂ (an expectation value of distance between the data points belonging to representative point 2 after splitting and representative point 2)+λ² . . . (32)

In Formula (32), w₁ is a weight of representative point 1 of one cluster in the case of splitting, and w₂ is a weight of representative point 2 of the other cluster in the case of splitting.

Returning to FIG. 15, in a case where the representative point splitting unit 31 satisfies the condition of Formula (4), an example is indicated below in which a representative point is split into two, at the center of the representative point, in dimension n in which the condition is satisfied. For example, it is assumed that (center, weight, maximum value, minimum value) of an original representative point are (u_{old}, w_{old}, p_{old}, q_{old}), respectively. u_{old} includes 1^{st} dimension value u (1) to d^{th} dimension value u (d). p_{old} includes 1^{st} dimension value p (1) to d^{th} dimension value p (d). q_{old} includes 1^{st} dimension value q (1) to d^{th} dimension value q (d).

It is assumed that a representative point is split into two in the n^{th} dimension. At this time, the values of two representative points after splitting (u₁, w₁, p₁, q₁), (uᵣ, wᵣ, pᵣ, qᵣ) are respectively updated to Formula (6) to Formula (13) below, with respect only to values of the n^{th} dimension, and, with respect to values other than the n^{th} dimension, values of the original representative point are taken over.

u₁(n)=(u(n)+q(n))/2 (6)

w₁=w_{old}(u(n)−q(n))/(p(n)−q(n)) (7)

p₁(n)=u(n) (8)

q₁(n)=q(n) (9)

uᵣ(n)=(u(n)+p(n))/2 (10)

wᵣ=w_{old}(p(n)−u(n))/(p(n)−q(n)) (11)

pᵣ(n)=p(n) (12)

qᵣ(n)=u(n) (13)

In addition, in a case where the representative point splitting unit 31 adds data points to a representative point, a sequential update of the representative point is performed. For example, it is assumed that (center, weight, maximum value, minimum value) of a representative point are (u_{old}, w_{old}, P_{old}, q_{old}), respectively, and an input data point is x. In this case, (center, weight, maximum value, minimum value) of the representative point after update become (u_{new}, w_{new}, p_{new}, q_{new}), respectively. u_{new}, w_{new}, p_{new}, and q_{new} are respectively represented by Equation (14) to Equation (17) below.

u_{new}=(w_{old}u_{old}+X)/(w_{old}+1) (14)

w_{new}=w_{old}+1 (15)

p_{new}=max(p_{old},x) (16)

q_{new}=min(q_{old},x) (17)

The clustering unit 14A executes batch clustering processing by inputting weighted representative points which are included in grids registered in the grid list 21. However, in the case of the weighted representative points, the objective function is changed from Formula (3) to Formula (18) below.

$$L ( x , c ) = {\sum }_{x ∈ X \{ u ∈ C \}} w min {‖ x - u ‖}^{2} + {λ}^{2} k \qquad ( 18 )$$

Here, x indicates a data point included in the input d-dimension data point group, u is the cluster center, k is the number of clusters, λ is a parameter which determines a cluster particle size, and w is a weight.

In this manner, since the objective function is changed, a condition in which a new cluster is generated is changed such that the new cluster is generated when the Euclid distance between data points is λ/\sqrt{w} or more. That is, in a case where the distance between a representative point and a center that is closest to the representative point in the cluster center set is λ/\sqrt{w} or more, the clustering unit 14A adds the representative point to the cluster center set. That is, the clustering unit 14A generates a new cluster including the representative point as the center thereof. Here, the above condition is one in a case where the Euclidean distance is used as the distance function to determine a cluster addition condition, but there exists an equivalent condition in a case where another function is used. For example, in a case where the squared Euclidean distance is used as the distance function, a condition in which a new cluster is generated is that data points are separated by λ²/w or more, but since the squared Euclidean distance is obtained by taking a square of an Euclidean distance, the condition is equivalent to a condition in which the Euclidean distance is used.

Representative Point Splitting Processing Flow Chart

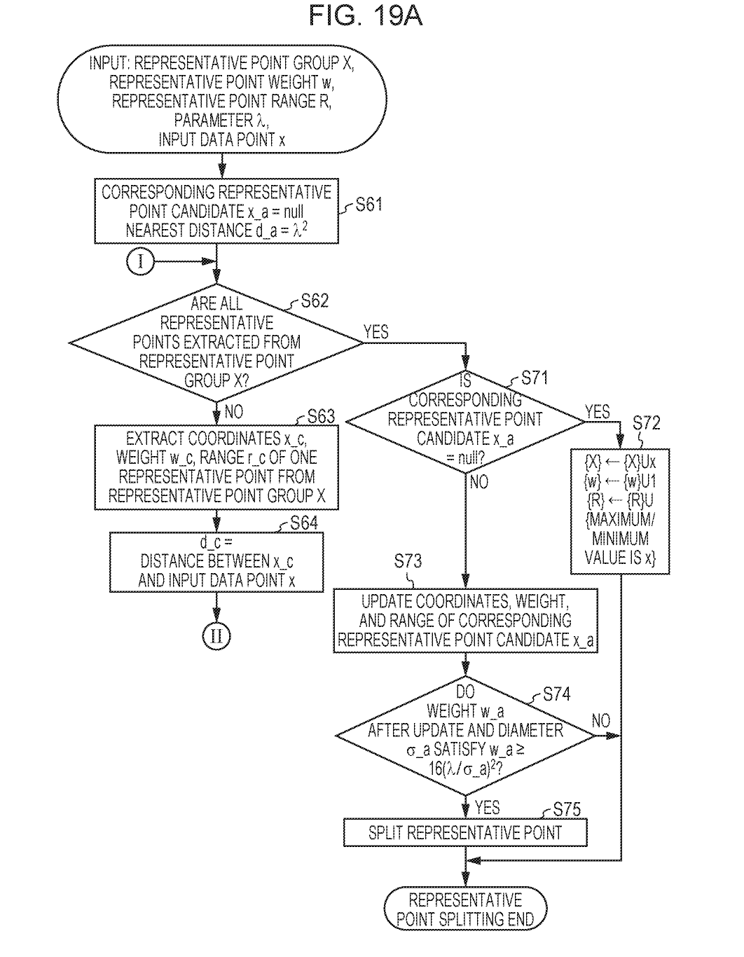

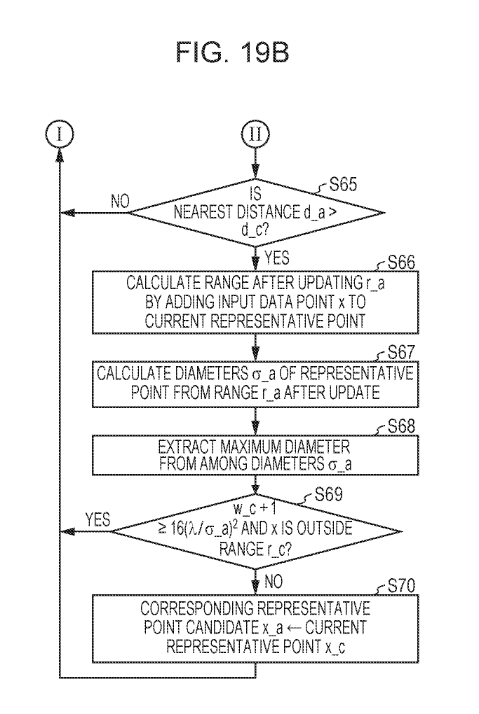

An operational flowchart of representative point update processing according to Applied Example 2 is described with reference to FIGS. 19A and 19B. FIGS. 19A and 19B are diagrams illustrating an operational flowchart for representative point splitting processing according to Applied Example 2. Here, the representative point splitting unit 31 acquires a representative point group X, a weight w, a representative point range R, a parameter λ which determines a cluster particle size, and an input data point x, as input parameters.

First, the representative point splitting unit 31 sets a corresponding representative point candidate x_a at null as an initial value, and sets a nearest distance d_a at λ² (step S61). Here, the corresponding representative point candidate means a candidate for a representative point to be split.

The representative point splitting unit 31 determines whether or not all the representative points are extracted from the data point group X (step S62). In a case where it is determined that not all the representative points are extracted (step S62: No), the representative point splitting unit 31 extracts coordinates x_c, a weight w_c, a range r_c of one representative point from the representative point group X (step S63).

The representative point splitting unit 31 calculates a distance between the coordinates x_c of the representative point and the input data point x, and the calculated distance is set to d_c (step S64). The representative point splitting unit 31 determines whether or not the distance d_c is smaller than the nearest distance d_a (step S65). In a case where it is determined that the distance d_c is not smaller than the nearest distance d_a (step S65: No), the process transitions to step S62 so as to cause the representative point splitting unit 31 to extract subsequent representative points.

Meanwhile, in a case where it is determined that the distance d_c is smaller than the nearest distance d_a (step S65: Yes), the representative point splitting unit 31 calculates a range r_a after update, based on data points obtained by adding the input data point x to current representative point (step S66). For example, the representative point splitting unit 31 calculates the range after update in a case where current representative point is updated by utilizing Formula (16) and Formula (17).

The representative point splitting unit 31 calculates diameters o_a of the representative points from the range r_a after update (step S67), and extracts the maximum diameter from among the calculated diameters σ_a (step S68). Then, the representative point splitting unit 31 determines whether or not w_c+1≧16(λ/σ_a)² and the input data point x is outside the range r_c of the current representative point (step S69). In a case where it is determined that w_c+1≧16(λ/σ_a)² and the input data point x is outside of the range r_c of the current representative point (step S69: Yes), the process transitions to step S62 to cause the representative point splitting unit 31 to extract the subsequent representative points. That is, even if w_c+1≧16(λ/σ_a)², when the input data point x is outside of the range r_c of the current representative point, the process transitions to step S62 so that the current representative point is not set as the corresponding representative point candidate.

Meanwhile, w_c+1<16(λ/σ_a)² or it is determined that the input data points x are not outside the range r_c of the current representative point (step S69: No), the representative point splitting unit 31 sets the current representative points x_c as the corresponding representative points candidate x_a (step S70). Then, the process transitions to step S62 to cause the representative point splitting unit 31 to extract the subsequent representative points.

In step S62, in a case where it is determined that all the representative points are extracted (step S62: Yes), the representative point splitting unit 31 determines whether or not the corresponding representative point candidate x_a is null (step S71). In a case where it is determined that the corresponding representative point candidate x_a is null (step S71: Yes), the representative point splitting unit 31 adds the input data point x to the representative point group X as a representative point. At this time, the representative point splitting unit 31 sets the weight w of the added representative point at one, and the range R of the added representative point is set so that the maximum value is x and the minimum value is x (step S72). Then, the representative point splitting unit 31 ends representative point splitting processing.

Meanwhile, in a case where it is determined that the corresponding representative points candidate x_a is not null (step S71: No), the representative point splitting unit 31 updates the coordinates, weight, and range of the corresponding representative point candidate x_a (step S73). That is, the representative point splitting unit 31 adds the input data point x to the corresponding representative point candidate x_a. For example, the representative point splitting unit 31 adds the input data point x to the corresponding representative point candidate x_a, and updates the coordinates of corresponding representative point candidate x_a by utilizing Formula (14). The representative point splitting unit 31 adds the input data point x to the corresponding representative points candidate x_a, and updates the weight w_a of the corresponding representative point candidate x_a by utilizing Formula (15). The representative point splitting unit 31 adds the input data point x to the corresponding representative points candidate x_a, and updates the maximum value of the corresponding representative point candidate x_a by utilizing Formula (16). The representative point splitting unit 31 adds the input data point x to the corresponding representative points candidate x_a, and updates the minimum value of the corresponding representative point candidate x_a by utilizing Formula (17).

Then, the representative point splitting unit 31 determines whether or not the weight w_a and diameter σ_a after update satisfy w_a≧16(λ/σ_a)² (step S74). In a case where it is determined that the weight w_a and the diameter σ_a after update satisfy w_a≧16(λ/σ_a)² (step S74: Yes), the representative point splitting unit 31 splits the representative point of the corresponding representative point candidate x_a (step S75). For example, the representative point splitting unit 31 splits the representative point of the corresponding representative point candidate x_a by utilizing Formula (6) and Formula (13). Then, the representative point splitting unit 31 ends representative point splitting processing.

In a case where it is determined that the weight w_a and the diameter σ_a after update does not satisfy w_a≧16(λ/σ_a)² (step S74: No), the representative point splitting unit 31 ends representative point splitting processing by not splitting the representative point of the corresponding representative point candidate x_a.

Clustering Processing Flow Chart

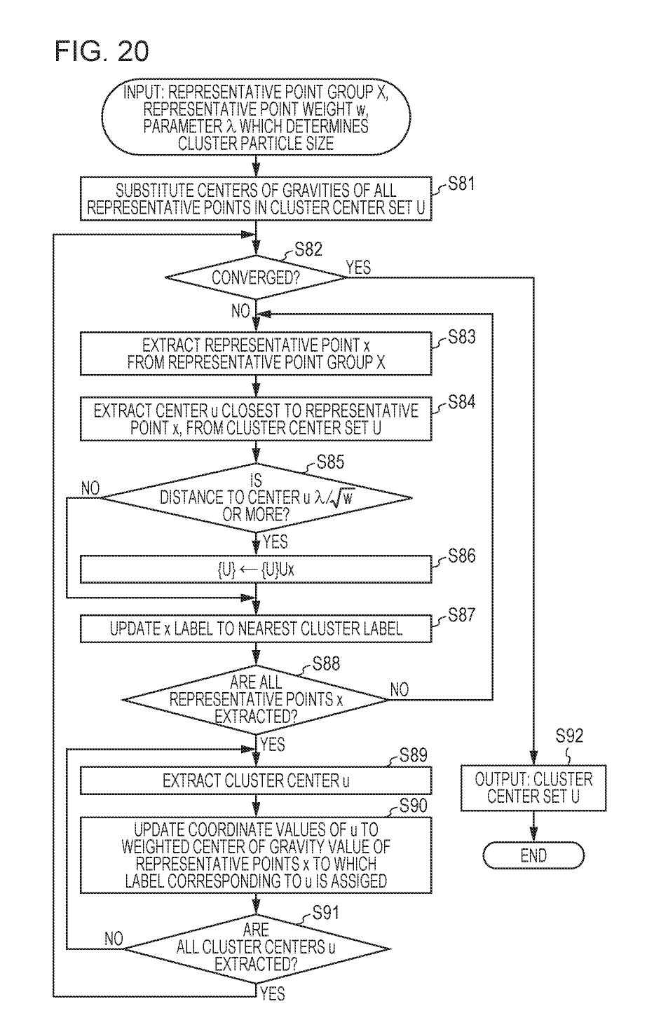

FIG. 20 is a diagram illustrating an operational flowchart for clustering processing according to Applied Example 2. Here, in FIG. 20, a case is described where the weighted DP-means method is applied, and the Euclidean distance is used as a distance function for determining cluster addition. The clustering unit 14A acquires representative point group X, weight w of the representative point, and a parameter λ which determines a cluster particle size, as input parameters.

The clustering unit 14A sets centers of gravity of all the representative points in the cluster center set U (step S81). The clustering unit 14A determines whether or not the clustering processing has converged (step S82). In a case where it is determined that the clustering processing has not converged (step S82: No), the clustering unit 14A extracts a representative point x from the representative point group (step S83). Then, the clustering unit 14A extracts, from the cluster center set U, a center u having the closest distance from the extracted representative point x (step S84).

The clustering unit 14A determines whether or not the distance between the representative point x and the center u is λ/\sqrt{w} or more (step S85). In a case where it is determined that the distance between the representative points x and the center u is λ/\sqrt{w} or more (step S85: Yes), the clustering unit 14A adds the representative point x to the cluster center set U (step S86). Then, the clustering unit 14A transitions to step S87.

Meanwhile, in a case where it is determined that the distance between the representative points x and the center u is notλ/\sqrt{w} or more, that is, smaller than λ/\sqrt{w} (step S85: No), the clustering unit 14A transitions to step S87. In step S87, the clustering unit 14A updates the label of the representative point x to a label of the nearest cluster (step S87).

Subsequently, the clustering unit 14A determines whether or not all the representative points x are extracted from the representative point group (step S88). In a case where it is determined that not all the representative points x are extracted (step S88: No), the clustering unit 14A transitions to step S83 so as to extract the subsequent representative points.

Meanwhile, in a case where it is determined that all the representative points x are extracted (step S88: Yes), the clustering unit 14A extracts a cluster center u from the cluster center set U (step S89). The clustering unit 14A updates coordinate values of the extracted u to weighted center of gravity values of the representative point to which the label corresponding to u is assigned (step S90).

Then, the clustering unit 14A determines whether or not all the cluster centers u are extracted from the cluster center set U (step S91). In a case where it is determined that not all the cluster centers u are extracted (step S91: No), the clustering unit 14A transitions to step S89 so as to extract a subsequent cluster center. Meanwhile, in a case where it is determined that all the cluster centers u are extracted (step S91: Yes), the clustering unit 14A transitions to step S82 so as to carry out convergence determination.

Then, the clustering unit 14A transitions to step S82 to carry out convergence determination. In step S82, in a case where it is determined that that the clustering processing has converged (step S82: Yes), the clustering unit 14A outputs the cluster center set U (step S92), and the clustering processing ends.

### Applied Example 2 Effects

According to Applied Example 2, the information processing device 1 holds the range of data points which are included in a new representative point. In a case where the weight of the new representative point exceeds a value that is inversely proportional to the square of the parameter indicating a range of data points in which the new representative point is included, the information processing device 1 splits the new representative point so that the new representative point is included in a different cluster. In this case, in a case where a value of the data point exceeds a predetermined value, the information processing device 1 is able to perform clustering so that the objective function value becomes small, by splitting the representative point so that new representative points are respectively included in different clusters. That is, even in a case where the representative points are utilized, the information processing device 1 is able to perform clustering without reducing precision.

In addition, according to Applied Example 2, when the information processing device 1 performs clustering processing by using the weighted representative points, the threshold of a distance from the cluster center which is permitted as the same cluster is set at a value which is inversely proportional to the square root of the weight of the representative point. In this case, in a case where the information processing device 1 performs weighted clustering, it is possible to perform clustering with good precision by setting the threshold of the distance from the cluster center which is permitted as the same cluster, at a threshold which is determined based on the weighting.

### Applied Example 3

Here, in Applied Example 2, description was given of the clustering unit 14A which performs batch clustering processing by inputting weighted representative points and changing an objective function from Formula (3) to Formula (18). That is, the clustering unit 14A allocates respective representative points to the nearest clusters, and when a distance between the input weighted representative point and the nearest cluster center is λ/\sqrt{w} or more, a new cluster is generated. Here, w is the weight of an input representative point, and λ is a parameter which determines a cluster particle size. However, the clustering unit 14A is not limited thereto, and two near weighted representative points may be clustered (integrated).

Therefore, in Applied Example 3, a case is described in which near weighted representative points are clustered (integrated) in clustering in which weighted representative points are used.

Information Processing Device Configuration According to Applied Example 3

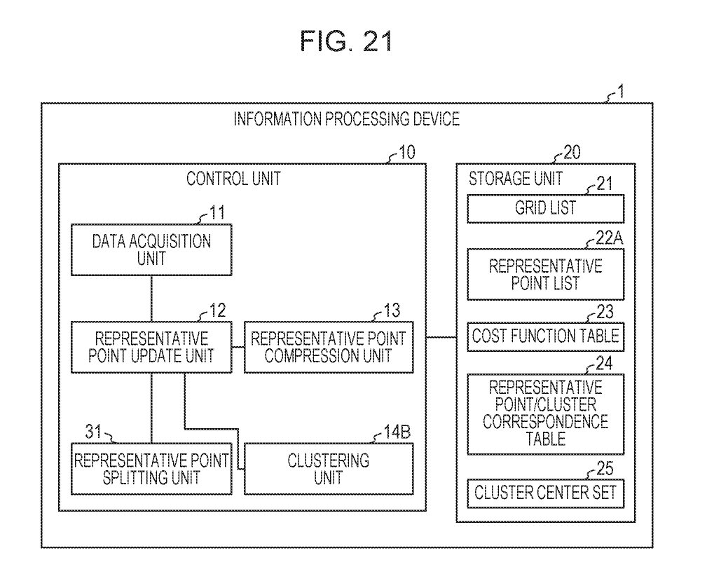

FIG. 21 is a functional block diagram illustrating a configuration of an information processing device according to Applied Example 3. Here, due to the same configuration as the information processing device 1 which is illustrated in FIG. 15 being indicated with the same reference numerals, description of the overlapping configuration and of the operation are omitted. A difference between Applied Example 2 and Applied Example 3 is a point in which the clustering unit 14A is changed to a clustering unit 14B. A difference between Applied Example 2 and Applied Example 3 is a point in which a cost function table 23, a representative point/cluster correspondence table 24, and a cluster center set 25 are added to a memory unit 20.

The clustering unit 14B selects and integrates two representative points from among a plurality of representative points. For example, the clustering unit 14B selects two representative points, by using the cost function, from among the plurality of representative points, and integrates the two representative points in a case where a condition is matched in which the two representative points are integrated. Here, the cost function is a function which calculates a degree of improvement in a case in which the two representative points are assumed to be integrated. Here, detail description of the condition in which the cost function and the two representative points are integrated will be described later. In addition, it is possible to realize a process in which two targets are selected and integrated using a Merge algorithm. As the Merge algorithm, for example, a technique described in ‘J. Lee et al., “Online video segmentation by Bayesian split-merge clustering”, in ECCV2012′, may be used.

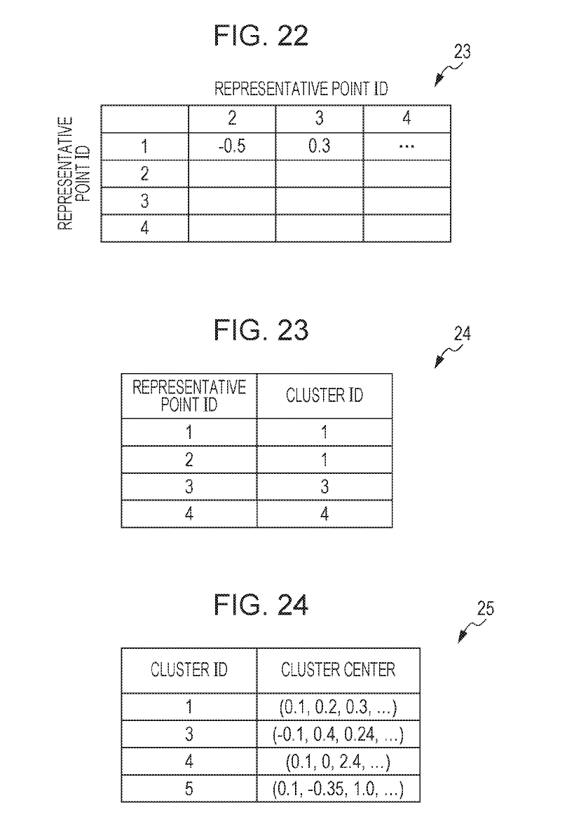

Here, a data structure of the cost function table 23 is described with reference to FIG. 22. FIG. 22 is a diagram illustrating an example of the data structure of the cost function table according to Applied Example 3. As illustrated in FIG. 22, the cost function table 23 stores a cost function value with respect to two representative point IDs. The representative point ID is an identifier (ID) which identifies a representative point. For example, a cost function value with respect to the two representative point IDs of “1” and “2” is −0.5. A cost function value with respect to the two representative point IDs of “1” and “3” is 0.3. The cost function value depends on the design of a cost function, but, for example, the smaller the cost function value the greater the degree of improvement.

The data structure of the representative point/cluster correspondence table 24 is described with reference to FIG. 23. FIG. 23 is a diagram illustrating an example of a data structure of the representative point/cluster correspondence table according to Applied Example 3. As illustrated in FIG. 23, the representative point/cluster correspondence table 24 stores a representative point ID and a cluster ID in association with each other. The representative point ID is an ID which identifies a representative point. The cluster ID is an ID which identifies a cluster. For example, in a case where a representative point ID is “1”, “1” is stored as the cluster ID. In a case where the representative point ID is “2”, “1” is stored as the cluster ID. This means that the cluster with representative point ID “1” is identical with the cluster with the representative point ID “2”.

The data structure of the cluster center set 25 is described with reference to FIG. 24. FIG. 24 is a diagram illustrating an example of the data structure of the cluster center set according to Applied Example 3. As illustrated in FIG. 24, the cluster center set 25 stores a cluster ID and a cluster center in association with each other. The cluster ID is an ID which identifies a cluster. The cluster center is center coordinates of the cluster. For example, in a case where the cluster ID is “1”, (0.1, 0.2, 0.3, . . . ) are stored as the cluster center.

Clustering Processing Flow Example

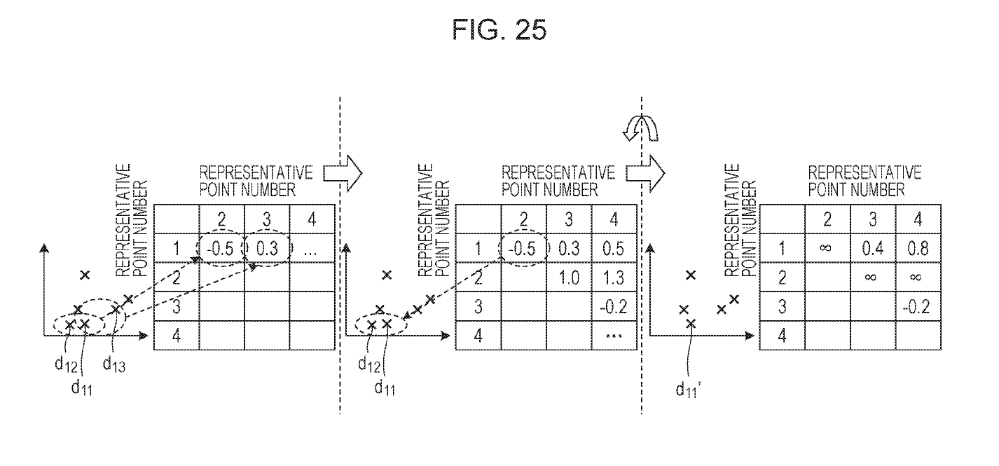

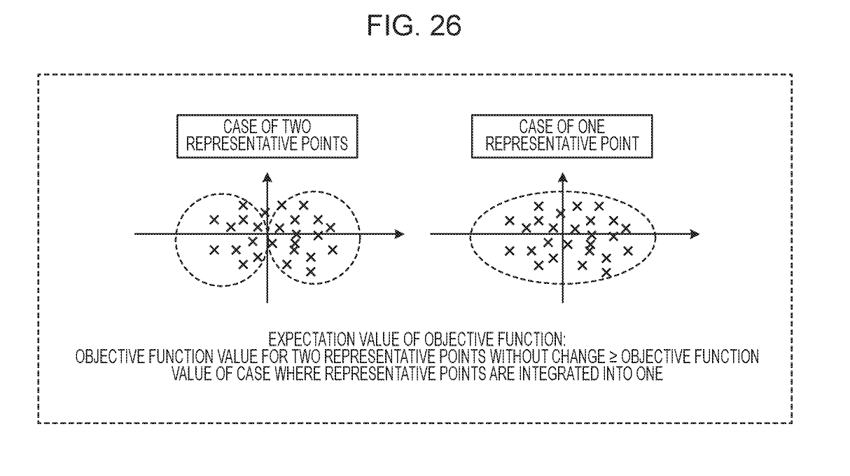

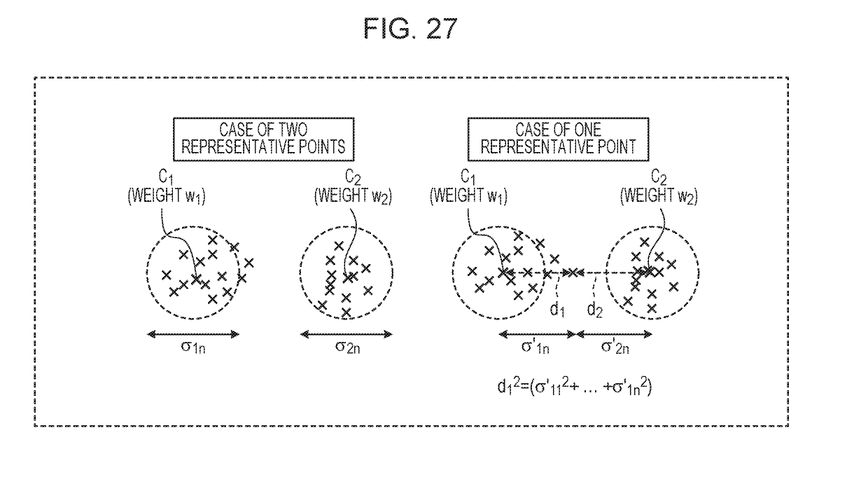

FIG. 25 is a diagram illustrating an example of a flow of clustering processing according to Applied Example 3. Here, the clustering processing is assumed to be designed such that the larger the degree of improvement, the smaller the cost function value.

As illustrated in the left view of FIG. 25, the clustering unit 14B calculates a degree of improvement in the cost function in a case where two representative points are assumed to be integrated. For example, the clustering unit 14B selects a representative point d₁₁ of “1” and a representative point d₁₃ of “3” as the representative point numbers, and calculates a degree of improvement in the cost function in a case where the selected two representative points are integrated. Here, the cost function value of the representative point d₁₁ of the representative point number “1” and the representative point d₁₃ of the representative point number “3” is 0.3. The clustering unit 14B selects a representative point d₁₁ of “1” and a representative point d₁₂ of “2” as the representative point numbers, and calculates a degree of improvement in the cost function in a case where the selected two representative points are integrated. Here, the cost function value of the representative point d₁₁ of the representative point number “1” and the representative point d₁₂ of the representative point number “2” is −0.5. In the same manner, the clustering unit 14B calculates a degree of improvement in the cost function in a case where another two representative points are assumed to be integrated.

As illustrated in the center view of FIG. 25, the clustering unit 14B selects two representative points having the maximum degree of improvement in the cost function. Here, the two representative points having the maximum degree of improvement in the cost function are two representative points which are indicated by the representative point d₁₁ of the representative point number “1” and the representative point d₁₂ of the representative point number “2”.

As illustrated in the right view in FIG. 25, the clustering unit 14B integrates the two representative points in a case of matching the conditions in which the selected two representative points are integrated. Here, the clustering unit 14B integrates the representative point d₁₁ of the representative point number “1” and the representative point d₁₂ of the representative point number “2”, and integrates the representative point d₁₂ of the representative point number “2” with the representative point d₁₁ of the representative point number “1”. Thereafter, the clustering unit 14B updates the representative point d₁₁ of the representative point number “1” to a weighted center of gravity d₁₁′, which is a weighted center of gravity for the two representative points and whose cluster ID is “1”. Then, the clustering unit 14B recalculates cost functions for the representative point d₁₁′ on which integration has been performed and for the other representative points.

Then, the clustering unit 14B selects the two representative points having a maximum degree of improvement in the cost function by using the recalculated results, and continues the clustering processing until the selected two representative points do not satisfy the integration conditions.

Representative Points Integration Conditions

Here, a condition under which the representative points are integrated are described with reference to FIG. 26. FIG. 26 is a diagram describing conditions under which representative points are integrated according to Applied Example 3.

As illustrated in FIG. 26, a left view is a state before the representative points are integrated, and is a case of two representative points. A right view is a state after the representative points are integrated, and is a case of one representative point. In this case, similarly to the discussion about a condition under which a representative point is split, a condition under which representative points are integrated is that an expectation value of the objective function after the representative points are integrated becomes smaller than that before the representative points are integrated. That is, when an expectation value of the objective function in case where two representative points are integrated into one is smaller than an expectation value of the objective function in case where the two representative points remain unchanged, it is preferable to integrate the two representative points.

Here, in a case where the representative points are weighted, an expectation value of the objective function is calculated, according to Formula (18), by using a product of a weight value and an expectation value of distance with respect to the representative points. That is, the expectation value of the objective function in the case where two representative points are integrated into one is calculated, by using a product of a sum of weights of the two representative points and an expectation value of distance between a data point belonging to the two representative points and the representative point of an integration destination, and an item calculated from a parameter determining a cluster particle size. The expectation value of the objective function in the case where the two representative points are not integrated into one is calculated, by using a sum of a first product and a second product, and an item calculated from a parameter determining the cluster particle size, where the first product is a product of a weight of one representative point (first representative point) and an expectation value of distance between a data point belonging to the first representative point and the first representative point, and the second product is a product of a weight of the other representative point (second representative point) and an expectation value of distance between a data point belonging to the second representative point and the second representative point.

Cost Function

A cost function in a case where representative points have a uniform distribution is represented, for example, in Formula (19) below.

S_{COST}(C₁,C₂)=w₁×d₁²+w₂×d₂²−λ² (19)

Here, C₁ and C₂ are representative points, respectively. w₁ is a weight of C₁, and w₂ is a weight of C₂. d₁ is a distance between C₁ and an integration-destination representative point (having a weighted center of gravity of C₁ and C₂) into which the representative points have been integrated, and d₂ is a distance between C₂ and the integration-destination representative point (having a weighted center of gravity of C₁ and C₂) into which the representative points have been integrated. λ is a parameter which determines the cluster particle size.

Derivation of the cost function which is represented by Formula (19) is described with reference to FIG. 27. FIG. 27 is a diagram illustrating a premise for derivation of the cost function according to Applied Example 3.

As illustrated in FIG. 27, a left-side view indicates a state before the representative points are integrated, and is a case of two representative points. C₁ is a representative point having a weight of w₁. σ₁ₙ is a range in n^{th} dimension of the representative point C₁. C₂ is a representative point having a weight of w₂. σ₂ₙ is a range in n^{th} dimension of the representative point C₂. Under such assumptions, an expectation value of error of a data point belonging to the representative point C₁ is represented by Formula (20) below.

An expectation value k₁ of error of a data point=(σ₁₁²/12+ . . . +σ₁ₙ²/12+ . . . ) (20)

Here, in Formula (20), expectation values of error terms of the respective dimensions are added.

In the same manner, an expectation value of error of a data point belonging to the representative point C₂ is represented by Formula (21) below.

An expectation value k₂ of error of a data point=(σ₂₁²/12+ . . . +σ₂ₙ²/12+ . . . ) (21)

Here, in Formula (21), expectation values of error terms of the respective dimensions are added.

A right-side view indicates a state after representative points are integrated, and is a case of one representative point. C₁ and C₂ are the same as in the left-side view. σ′₁ₙ is in a range between the representative point C₁ and an integrated representative point into which the representative points C₁ and C₂ have been integrated in n^{th} dimension, and d₁ is a distance between C₁ and the integrated representative point. σ′₂ₙ is in a range between the representative point C₂ and the integrated representative point into which the representative points C₁and C₂ have been integrated in n^{th} dimension, and d₂ is a distance between C₂ and the integrated representative point. Under such assumptions, an expectation value of error of dimension n of a data point belonging to the representative point C₁ is represented by Formula (22).

(An expectation value of error of dimension n of a data point)

$$= \frac{1}{{σ}_{ln}} {\int }_{{σ}_{ln}^{′} - \frac{{σ}_{ln}}{2}}^{{σ}_{ln}^{′} + \frac{{σ}_{ln}}{2}} {x}^{2} d x \\ = {σ}_{ln}^{′2} + \frac{{σ}_{ln}^{2}}{12} \qquad ( 22 )$$

Accordingly, an expectation value of error of a data point belonging to the representative point C₁ is represented by Formula (23) below.

Expectation value g₁ of the error of the data points=(σ′₁₁²+ . . . +σ′ᵢₙ²+ . . . )+(σ₁₁²/12+ . . . +σᵢₙ²/12+ . . . ) (23)

Here, in Formula (23), expectation values of error terms of the respective dimensions are added, and (σ′₁₁²+ . . . +σ′₁ₙ²+ . . . ) corresponds to d₁² indicating a distance between the integrated representative point and C₁.

In the same manner, an expectation value of error of a data point belonging to the representative point C₂ is represented by Formula (24) below.

Expectation value g₂ of the error of the data points=(σ′₂₁²+ . . . +σ′₂ₙ²+ . . . )+(σ₂₁²/12+ . . . +σ₂ₙ²/12+ . . . ) (24)

Here, in Formula (24), expectation values of error terms of the respective dimensions are added, and (σ′₂₁²+ . . . +σ′₂ₙ²+ . . . ) corresponds to d₂² which indicates a distance between the integrated representative point and C₂.

By substituting Formula (23) and Formula (24) for an objective function of a case of weighted representative points which is indicated by Formula (18), an expectation value M₁ of an objective function in the case of one representative point is represented by Formula (25) below.

M₁=w₁×g₁+w₂×g₂+λ²={d₁²+(σ₁₁²/12+ . . . +σ₁ₙ²/12+ . . . )}+w₂×{d₂²+(σ₂₁²/12+ . . . +σ₂ₙ²/12+ . . . )}+λ² (25)

By substituting Formula (20) and Formula (21) for an objective function of a case of weighted representative points which is indicated by Formula (18), an expectation value M₂ of an objective function in the case of two representative points is represented by Formula (26) below.

M₂=w₁×k₁+w₂×k₂+2λ²=w₁×(σ₁₁²/12+ . . . +σ₁ₙ²/12+ . . . )+w₂×(σ₂₁²/12+ . . . +σ₂ₙ²/12+ . . . )+2λ² (26)

Since a cost function S_{COST}(C₁, C₂) is obtained by subtracting the expectation value M₂ of the objective function in the case of two representative points, which is represented by Formula (26), from the expectation value M₁ Formula (25) of the objective function in the case of one representative point, which is represented by Formula (25), the cost function Scosr (C₁, C₂) is able to be represented by Formula (19) described above. That is, when the cost function S_{COST}(C₁, C₂) is 0 or less, it is preferable to integrate two representative points C₁ and C₂.

In the above-mentioned examples, an expectation value of error of a data point is calculated by using a distance d between the integrated representative point and a representative point K. However, a method for obtaining an expectation value of error of a data point is not limited thereto. For example, information on representative points before integration may be stored, and a difference between a first distance between the representative point K and the representative point before integration, and a second distance between the representative point K and the integrated representative point, may be calculated as an error. A cost function S_{COST}(C₁, C₂) of a case where such an expectation value of error of a data point is used is represented by Formula (27) below.

$${S}_{cost} ( {C}_{1} , {C}_{2} ) = {w}_{1} {\sum }_{K ∈ {C}_{1}} ( {d}_{new , K}^{2} - {d}_{old , K}^{2} ) + {w}_{2} {\sum }_{K ∈ {C}_{2}} ( {d}_{new , K}^{2} - {d}_{old , K}^{2} ) - {λ}^{2} \qquad ( 27 )$$

Here, d_{old, K} indicates a distance between the representative point K and the representative point before integration (cluster center), and d_{new, K} indicates a distance between the representative point K and the integrated representative point (cluster center).

In this way, by utilizing information on representative points before and after integration when the representative points are integrated, as an expectation value of error of a data point, it is possible to prevent errors from being accumulated due to loss of the representative points before integration.

Clustering Processing Flow Chart

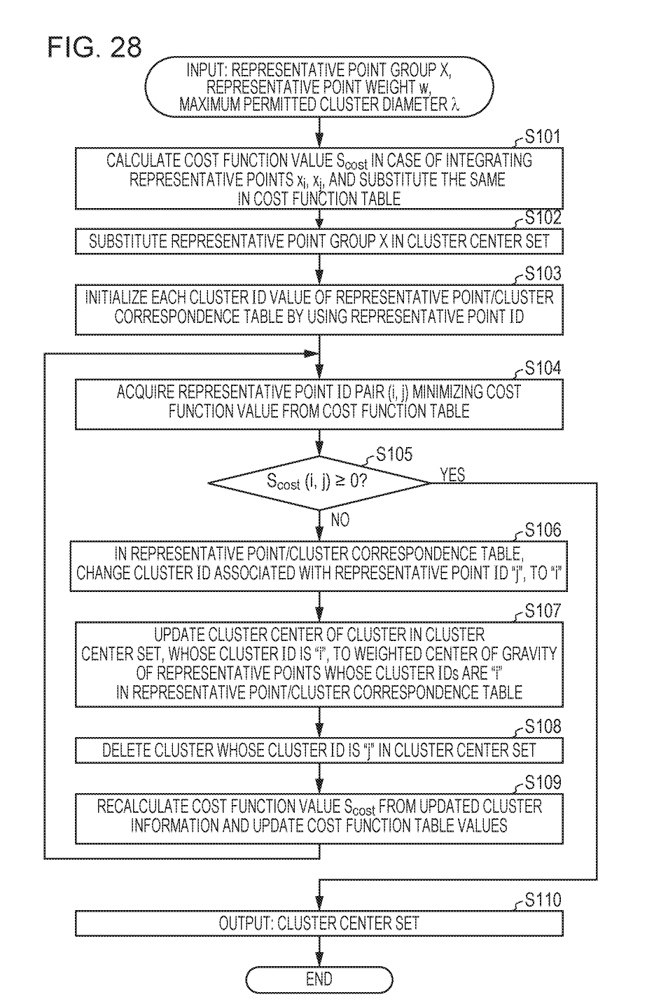

FIG. 28 is a diagram illustrating an operational flowchart for clustering processing according to Applied Example 3. Here, in FIG. 28, a case is described where the Merge algorithm is applied, and the Euclidean distance is used as a distance function to be used when cluster addition is determined. The clustering unit 14B acquires a representative point group X, weights w of representative points, and a maximum permitted cluster diameter X, as input parameters. The maximum permitted cluster diameter corresponds to a parameter which determines a cluster particle size.

The clustering unit 14B calculates a cost function value S_{COST} in a case of integration of representative points xᵢ and xⱼ, and substitutes the calculated result in the cost function table 23 (step S101). Here, i and j are representative point IDs (representative point numbers). The clustering unit 14B substitutes the representative point group X in the cluster center set U (step S102). Then, the clustering unit 14B initializes each cluster ID value of the representative point/cluster correspondence table 24 by using the representative point ID (step S103).

Subsequently, the clustering unit 14B acquires a representative point ID pair (i, j) which minimizes a cost function value, from the cost function table 23 (step S104). The clustering unit 14B determines whether or not the cost function value (i, j) is 0 or more (step S105). In a case where the cost function value (i, j) is determined to be 0 or more (step S105: Yes), the clustering unit 14B transitions to step S110.

Meanwhile, in a case where the cost function value (i, j) is determined to be less than 0 (step S105: No), the clustering unit 14B changes the cluster ID at which the representative point ID is “j” to “i” within the representative point/cluster correspondence table 24 (step S106). Or alternatively, the clustering unit 14B may change the cluster ID at which the representative point ID is “i” to “j”.

Then, the clustering unit 14B updates the cluster center of gravity for a cluster whose cluster ID within the cluster center set 25 is “i”, to a weighted center of gravity of representative points whose cluster IDs are “i” in the representative point/cluster correspondence table 24 (step S107). The clustering unit 14B deletes a cluster (a representative point) whose cluster ID is “j” within the cluster center set 25 (step S108).

Then, the clustering unit 14B recalculates the cost function value S_{COST} from the updated cluster information, and updates the values of the cost function table 23 (step S109). Then, the clustering unit 14B transitions to step S104.

In step S110, the clustering unit 14B outputs the cluster center set 25 (step S110). Then, the clustering unit 14B ends clustering processing.

### Applied Example 3 Effects

According to Applied Example 3, when clustering processing is performed using the representative points, the information processing device 1 selects two representative points, and in a case where an expectation value of the objective function of a case where the two representative points are integrated into one point is smaller than an expectation value of the objective function of a case where the two representative points are not integrated into one point, the two representative points are integrated in one point. In this case, even in a case where representative points are utilized, the information processing device 1 is able to perform clustering without reducing precision.

### Applied Example 4

In Applied Example 3, the clustering unit 14B integrates the two representative points in a case of matching a condition for integrating two representative points, and the integrated representative point into which the two representative points have been integrated is updated to a weighted center of gravity of the two representative points. However, the clustering unit 14B is not limited thereto, the integrated representative point may be updated as either one of two representative points in the case of matching a condition for integrating the two representative points.

Here, in a case of matching a condition for integrating two representative points, the clustering unit 14B according to Applied Example 4 integrates the two representative points by updating the integrated representative point as either one of the two representative points.

Information Processing Device Configuration According to Applied Example 4

Since the configuration of the information processing device 1 according to Applied Example 4 has the same configuration as the information processing device 1 according to Applied Example 3, the same reference numerals are used, and description of overlapping configuration will be omitted.

Clustering Processing Summary

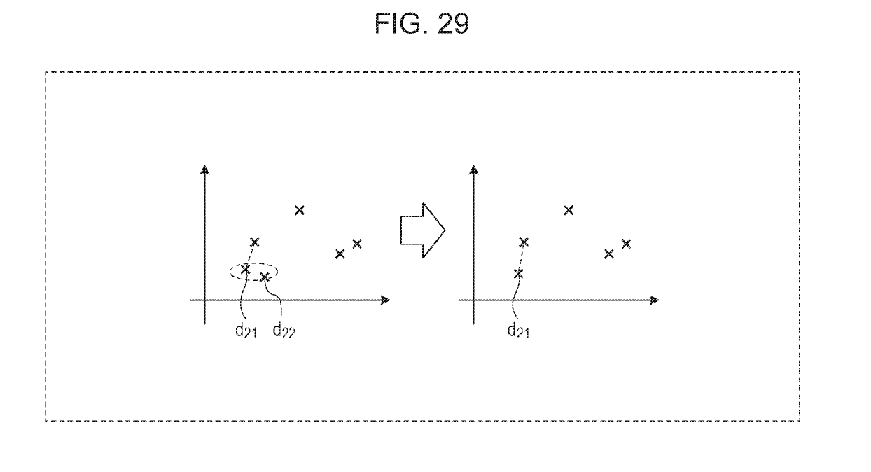

FIG. 29 is a diagram illustrating a summary of clustering processing according to Applied Example 4. As illustrated in FIG. 29, when the clustering unit 14B integrates two representative points, the clustering unit 14B does not integrates the two representative points into a point corresponding to the center of gravity of the two representative points, but into either one of the two representative points. Here, in a case where the clustering unit 14B integrates the two representative points d₂₁ and d₂₂, the clustering unit 14B integrates the two representative points d₂₁ and d₂₂ into the representative point d₂₁ out of the representative points d₂₁ and d₂₂. Thereby, since the integrated representative point, into which two representative points are integrated, does not move even when the clustering unit 14B performs integration, a problem does not occur that a representative point to be originally integrated fails to be integrated due to the movement of coordinates of representative points caused by integration. That is, for the clustering unit 14B, a problem does not occur that the integration condition is not satisfied when representative points moves due to the integration operation although the integration condition is satisfied if representative points does not move.

Clustering Processing Flow Example

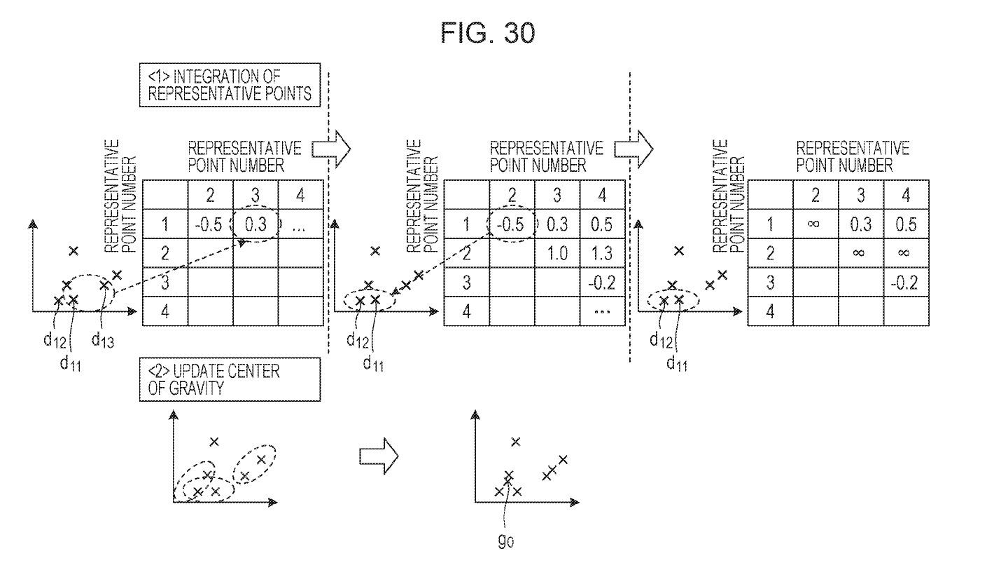

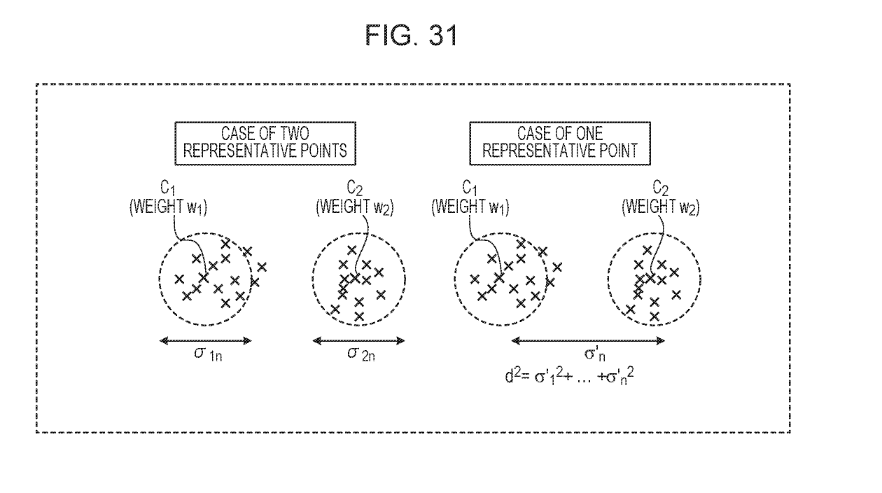

FIG. 30 is a diagram illustrating an example of a flow of clustering processing according to Applied Example 4. Here, it is assumed that the greater a degree of improvement, the smaller a cost function value is.

As illustrated in the upper stage left-side view of FIG. 30, the clustering unit 14B calculates a degree of improvement in the cost function value in a case where two representative points are assumed to be integrated. For example, the clustering unit 14B selects a representative point d₁₁ of “1” and a representative point d₁₃ of “3” as the two representative point numbers, and calculates a degree of improvement in the cost function value in a case where the selected two representative points are integrated. Here, the cost function value of the representative point d₁₁ of representative point number “1” and the representative point d₁₃ of representative point number “3” is 0.3. The clustering unit 14B selects a representative point d₁₁ of “1” and a representative point d₁₂ of “2” as the two representative point numbers, and calculates a degree of improvement in the cost function value in a case where the selected two representative points are integrated. Here, the cost function value of the representative point d₁₁ of the representative point number “1” and the representative point d₁₂ of the representative point number “2” is −0.5. In the same manner, the clustering unit 14B calculates a degree of improvement in the cost function value in a case where another two representative points are assumed to be integrated.

As illustrated in an upper stage center view of FIG. 30, the clustering unit 14B selects two representative points with a maximum degree of improvement in the cost function value. Here, the two representative points with a maximum degree of improvement in the cost function value are two representative points indicated by the representative point d₁₁ of the representative point number “1” and the representative point d₁₂ of the representative point number “2”.

As illustrated in the upper stage right-side view in FIG. 30, the clustering unit 14B integrates the two representative points in a case of matching the condition for integrating the selected two representative points. Here, the clustering unit 14B integrates the representative point d₁₁ of the representative point number “1” and the representative point d₁₂ of the representative point number “2”, and integrates the representative point d₁₂ of the representative point number “2” with the representative point d₁₁ of the representative point number “1”. Then, the clustering unit 14B updates only a cost function value in the cost function table 23, which is associated with each pair of representative point IDs including the representative point number “2” to be cancelled out by integration. Here, only a cost function value, which is associated with each pair of representative point IDs including the representative point number “2” in the cost function table 23, is updated to “c”. That is, at this timing, the clustering unit 14B does not update the representative point d₁₁ of the representative point number “1” to a weighted center of gravity of the two representative points whose cluster ID is “1”. Then, furthermore, the clustering unit 14B selects another pair of two representative points having a maximum degree of improvement in the cost function value, and clustering processing continues until the selected pair of two representative points does not satisfy the integration condition.

As illustrated in the lower stage left-side view in FIG. 30, in a case where integration occurs at least one time, the clustering unit 14B utilizes the weighted center of gravity of the two representative points which are integrated into the same representative point as coordinates of a new representative point. In this case, the clustering unit 14B integrates the same representative points, and updates the weighted center of gravity of the representative point d₁₁ of the representative point number “1”, which have been integrated into the same representative point, to a coordinate g₀ whose cluster ID is “1”.

Cost Function

Here, according to Applied Example 4, a cost function in a case where representative points have a uniform distribution is represented, for example, in Formula (28) below.

S_{mCOST}(C₁,C₂)=w₂×d²−λ² (28)

Here, C₁ and C₂ are respective representative points. w₂ is a weight of C₂. d is a distance between the representative point C₁ and the representative point C₂. λ is a parameter which determines a cluster particle size.

Derivation of the cost function which is represented by Formula (28) is described with reference to FIG. 31. FIG. 31 is a diagram illustrating a premise of derivation of the cost function according to Applied Example 4.

As illustrated in FIG. 31, a left-side view indicates a state before the representative points are integrated, and is a case of two representative points. C₁ is a representative point whose weight is w₁. σ₁ₙ is a range in n^{th} dimension of the representative point C₁. C₂ is a representative point whose weight is w₂. σ₂ₙ is a range in n^{th} dimension of the representative point C₂. Under such assumptions, an expectation value of error of a data point belonging to the representative point C₁ is the same as that in Formula (20). In the same manner, an expectation value of error of a data point belonging to the representative point C₂ is the same as that in Formula (21).

A right-side view indicates a state after the representative points are integrated, and is a case of one representative point. C₁ and C₂ are the same as those in the left-side view. σ′n is in a range between the representative point C₁ and representative point C₂ in n^{th} dimension, and d is a distance between the representative point C₁ and the representative point C₂. Under such assumptions, an expectation value of error of dimension n of a data point belonging to the representative point C₂ is represented by Formula (29) below.

An expectation value of error of dimension n of a data point belonging to C₂

$$= \frac{1}{{\partial }_{ln}} {\int }_{{σ}_{n}^{′} - \frac{{σ}_{2 n}}{2}}^{{σ}_{n}^{′} + \frac{{σ}_{2 n}}{2}} {x}^{2} d x \\ = {σ}_{n}^{′2} + \frac{{σ}_{2 n}^{2}}{12} \qquad ( 29 )$$

Accordingly, an expectation value of error of a data point belonging to the representative point C₂ is represented by Formula (30) below.

Expectation value g₃ of error of a data point=(σ′1²+ . . . +σ′n²+ . . . )+(σ₂₁²/12+ . . . +σ₂ₙ²/12+ . . . ) (30)

Here, in Formula (30), expectation values of error terms of respective dimensions are added. Here (σ′1²+ . . . +σ′n²+ . . . ) corresponds to d² which indicates a distance between the representative point C₁ and the representative point C₂.

An expectation value of error of a data point belonging to the representative point C₁ is the same as that in Formula (20).

By substituting Formula (30) and Formula (20) into an objective function of the case of weighted representative points which are indicated by Formula (18), an expectation value M₃ of an objective function in the case of one representative point is represented by Formula (31) below.

M₃=w₁×k₁+w₂×g₃=w₁×(σ₁₁²/12+ . . . +σᵢₙ²/12+ . . . )+w₂×{d²+(σ₂₁²/12+ . . . +σ₂ₙ²/12+ . . . )}+λ² (31)

An expectation value of the objective function in the case of two representative points is the same as M₂ which is represented by Formula (26).

Since a cost function S_{mCOST} (C₁, C₂) is obtained by subtracting the expectation value M₂ of the objective function in the case of two representative points, which is represented by Formula (26), from the expectation value M₃ of the objective function in the case of one representative point, which is represented by Formula (31), the cost function S_{mCOST} (C₁, C₂) is represented by the above mentioned Formula (28). That is, when the cost function S_{mCOST} (C₁, C₂) is 0 or less, it is preferable to integrate two representative points C₁ and C₂.

Clustering Processing Flow Chart

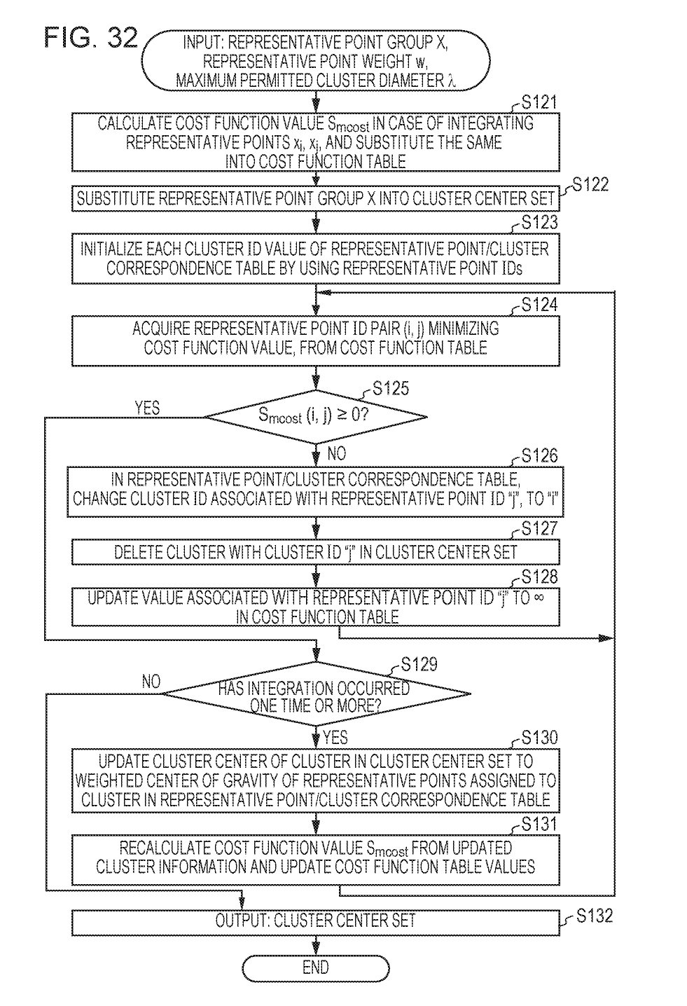

FIG. 32 is a diagram illustrating an operational flowchart for clustering processing according to Applied Example 4. Here, in FIG. 32, a case is described where the Merge algorithm is applied, and the Euclidean distance is used as a distance function to be used when cluster addition is determined. The clustering unit 14B acquires the representative point group X, weight w of a representative point, and maximum permitted cluster diameter λ, as input parameters. The maximum permitted cluster diameter corresponds to a parameter which determines a cluster particle size.

The clustering unit 14B calculates a cost function value S_{mCOST} in a case of integration of representative points xᵢ and xⱼ, and the calculated result is substituted into the cost function table 23 (step S121). Here, i and j are representative point IDs (representative point numbers). The clustering unit 14B substitutes the representative point group X into the cluster center set U (step S122). Then, the clustering unit 14B initializes each cluster ID value of the representative point/cluster correspondence table 24 using the representative point ID (step S123).

Subsequently, the clustering unit 14B acquires a pair of representative point IDs (i, j) minimizing the cost function value, from the cost function table 23 (step S124). The clustering unit 14B determines whether or not the cost function value (i, j) is 0 or more (step S125). In a case where the cost function value (i, j) is determined to be 0 or more (step S125: Yes), the clustering unit 14B transitions to step S129.

Meanwhile, in a case where the cost function value (i, j) is determined to be less than 0 (step S125: No), the clustering unit 14B changes the cluster ID associated with the representative point ID “j”, to “i” within the representative point/cluster correspondence table 24 (step S126). Or alternatively, the clustering unit 14B may change the cluster ID associated with the representative point ID “i”, to “j”.

Then, the clustering unit 14B deletes a cluster whose cluster ID is “j” within the cluster center set 25 (step S127). The clustering unit 14B updates a value that is associated with each pair of representative point IDs including “j” in the cost function table 23, to “o” (step S128). Then, the clustering unit 14B transitions to step S124.

In step S129, the clustering unit 14B determines whether or not integration has occurred one time or more (step S129). In a case where it is determined that integration has occurred one time or more (step S129: Yes), the clustering unit 14B performs the following processing on a cluster corresponding to representative points for which the integration has occurred. That is, the clustering unit 14B updates a cluster center of a cluster within the cluster center set 25 to a weighted center of gravity of representative points which are assigned to the cluster in the representative point/cluster correspondence table 24 (step S130).

Then, the clustering unit 14B recalculates the cost function value S_{mCOST} from the updated cluster information, and updates the values of the cost function table 23 (step S131). Then, the clustering unit 14B transitions to step S124.

Meanwhile, in a case where it is determined that integration has not occurred one time or more (step S129: No), the clustering unit 14B outputs the cluster center set 25 (step S132). Then, the clustering unit 14B ends clustering processing.

Applied Example 4 Effects

According to Applied Example 4, the information processing device 1 selects either one of the two representative points as a representative point of the integration destination, and furthermore, when the integration operation ends, recalculates coordinates of a representative point into which the two representative points have been integrated, by using information on the integrated representative point. In this case, the information processing device 1 does not move the coordinates of the representative point of the integration destination until the integration operation ends. As a result, the information processing device 1 is able to prevent representative points to be originally integrated, from not being integrated due to movement of coordinates of the representative points caused by the integration operation. In addition, even in a case where representative points are utilized, the information processing device 1 is able to perform clustering without reducing precision.

Here, objective function values, which are optimized using respective pieces of clustering processing that are described in Applied Examples 3 and 4, are calculated as below by experimentation. First, an objective function value which is optimized by clustering processing using the DP-means method is 7.33×10¹¹, and the calculation time therefor is 321.1219 seconds. An objective function value which is optimized by clustering processing according to Applied Example 3 is 3.32×10¹¹, and the calculation time therefor is 435.4864 seconds. An objective function value which is optimized by clustering processing according to Applied Example 4 is 3.24×10¹¹, and the calculation time therefor is 434.2837 seconds.

As mentioned above, objective function values which are optimized using clustering processing in Applied Examples 3 and 4 are small in comparison to other methods. That is, the smaller objective function value is obtained by performing the integration operation utilizing the Merge algorithm. That is, the objective function value is further improved when the integration operation is performed utilizing the Merge algorithm.

Others

Here, in Applied Example 1, the clustering unit 14 executes batch clustering processing by inputting weighted representative points within the grid list 21. At this time, it is described that the clustering unit 14 executes the objective function as Equation (3). However, the clustering unit 14 is not limited thereto, and may perform the objective function as Equation (18).

In addition, in Applied Example 1, it is described that the representative point compression unit 13 sets a new representative point by merging another representative point with a representative point which is selected from among representative points included in the grid so that the number of representative points included in the grid does not exceeds the maximum number of held points. However, the representative point compression unit 13 is not limited thereto. Nearby representative points are selected, an average position of the selected nearby representative points is calculated, and the average position may be set as a new representative point.

In addition, each configuration element of the illustrated information processing device 1 does not have to be physically configured as illustrated. That is, the specific mode of dispersion and integration of the information processing device 1 is not limited to the illustration, and it is possible to configure the entirety or a portion thereof so as to be functionally or physically dispersed or integrated in arbitrary units, depending on various loads, usage conditions, and the like. For example, the representative point update unit 12 and the representative point compression unit 13 may be integrated as one unit. In addition, the representative point update unit 12 may be dispersed to a generation unit which generates the grid, an addition unit which adds the data points to the grid, and a compression unit which causes the representative point compression unit 13 to compress the data. In addition, a storage unit 20 may be connected via a network, as an external device of the information processing device 1.

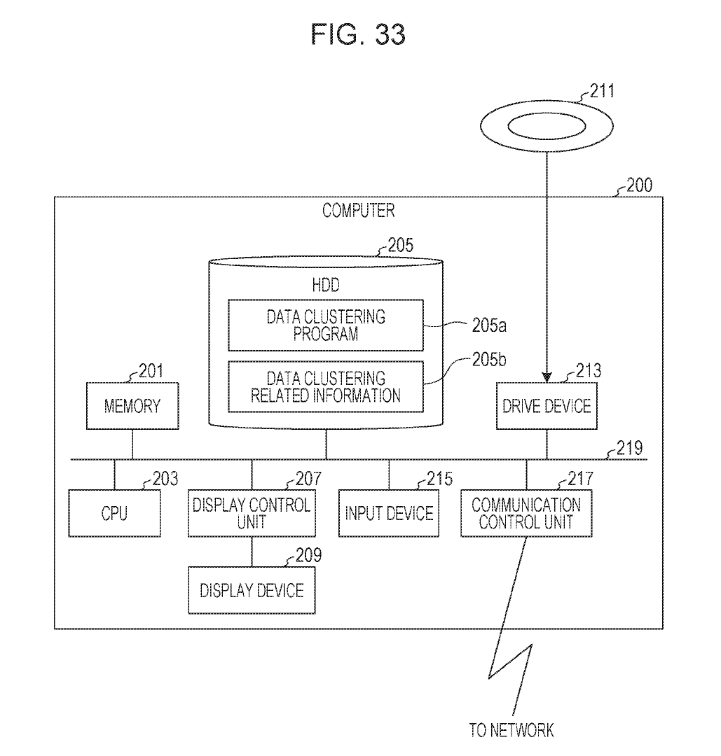

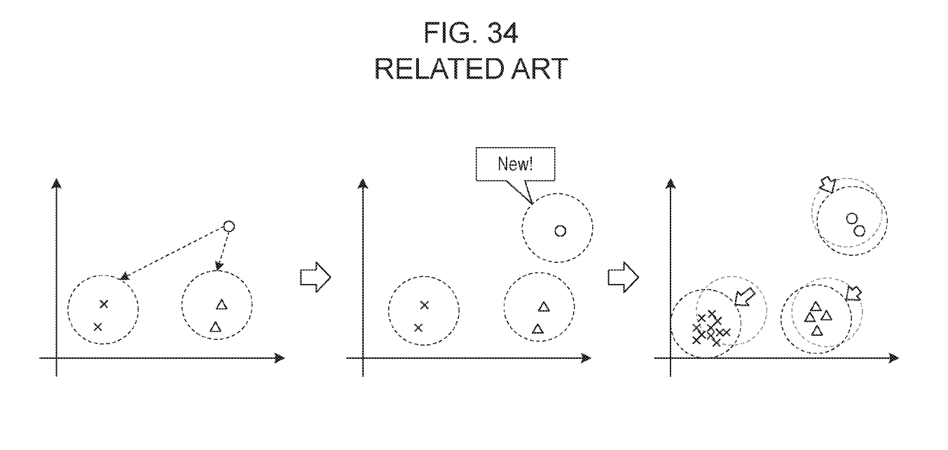

In addition, various processes which are described in the applied examples above are able to be realized by executing a program prepared in advance, by using a computer such as a personal computer or a work station. Therefore, an example of a computer which executes a data clustering program that realizes the same function as the information processing device 1 which is indicated in FIG. 1 is described below. FIG. 33 is a diagram illustrating an example of a computer which executes the data clustering program.

As indicated in FIG. 33, a computer 200 includes a CPU 203 which executes various arithmetic processes, an input device 215 which receives data input from a user, and a display control unit 207 which controls a display device 209. In addition, the computer 200 includes a drive device 213 which reads a program or the like from a storage medium, and a communication control unit 217 which performs reception of data with another computer via the network. In addition, the computer 200 includes a memory 201 which temporarily stores various information, and an HDD 205. Here, the memory 201, the CPU 203, the HDD 205, the display control unit 207, the drive device 213, the input device 215, and the communication control unit 217 are connected via a bus 219.

For example, the drive device 213 is a device for a removable disk 210. The HDD 205 stores a data clustering program 205a and data clustering related information 205b.

The CPU 203 reads the data clustering program 205a, loads the same into the memory 201, and executes a process. The process corresponds to each functional unit of the information processing device 1. The data clustering related information 205b corresponds to the grid list 21 and the representative point list 22. Then, for example, a removable disk 211 stores each set of information such as the data clustering program 205a.

Here, the data clustering program 205a may not necessarily be initially stored in the HDD 205. For example, a program is stored in a “portable physical medium” such as a floppy disk (FD), a CD-ROM, a DVD disc, an optical disc, or an IC card, which are inserted in the computer 200. Then, the computer 200 may be configured to read the data clustering program 205a therefrom to execute the same.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for clustering data in streaming clustering, the method comprising:
dividing a feature value space in which input data points are to be disposed, into a plurality of local regions;
determining a representative point independently for each of one or more local regions each including at least one data point;
in a case where a data point is added to a local region in which the representative point is disposed, determining a new representative point to which a weight is assigned, based on the added data point and the representative point; and
controlling a number of clusters by using the new representative point.

2. The method of claim 1, wherein
each of the plurality of local regions is configured as a d-dimensional hypercube whose side length is λ/\sqrt{d}, where λ is a threshold to determine a cluster particle size, and d is a number of dimensions for the feature value space.

3. The method of claim 1, wherein
each of the plurality of local regions is configured as a d-dimensional hypersphere whose diameter is threshold λ to determine a cluster particle size, where d is a number of dimensions for the feature value space.

4. The method of claim 1, wherein
in a case where each of the plurality of local regions is configured as a d-dimensional hypercube whose side length is λ/\sqrt{d}, where λ is a threshold to determine a cluster particle size, and d is a number of dimensions for the feature value space, or as a d-dimensional hypersphere whose diameter is the threshold λ, a maximum number of data points being held in each of the one or more local regions is set at the dimension number d.

5. The method of claim 1, wherein
in a case where a second group of data points are input after a first group of data points was input, the new representative point is determined, based on a first representative point determined for the first group of data points and the first and second groups of data points.

6. The method of claim 1, wherein
in a case where each of the plurality of local regions is configured as a d-dimensional hypercube whose side length is λ/\sqrt{d}, where λ is a threshold to determine a cluster particle size, and d is a number of dimensions for the feature value space, or as a d-dimensional hypersphere whose diameter is the threshold λ, a maximum number of data points held in each of the one or more local regions is set at 3×d×log (d).

7. The method of claim 1, further comprising:
holding information on a range of data points belonging to the new representative point in a first cluster; and
in a case where a weight of the new representative point is equal to or greater than a value that is inversely proportional to a square of a parameter indicating a range of data points belonging to the new representative point, splitting the new representative point into two representative points so that the two representative points are respectively included in different clusters.

8. The method of claim 1, further comprising:
splitting the new representative point into two representative points in a case where a first expectation value of an objective function which is obtained without splitting the new representative point is equal to or greater than a second expectation value of the objective function which is obtained as a result of splitting the new representative point into the two representative points.

9. The method of claim 1, further comprising:
splitting the new representative point into a first representative point and a second representative point in a case where a first value obtained based on the new representative point is equal to or greater than a second value obtained based on the first and second representative points, wherein
the first value is obtained from a product of a weight of the new representative point and an expectation value of distance between the new representative point and a data point belonging to the new representative point, and
the second value is obtained from a sum of:
a product of a weight of the first representative point and an expectation value of distance between the first representative point and a data point belonging to the first representative point,
a product of a weight of the second representative point and an expectation value of distance between the second representative point and a data point belonging to the second representative point, and
an item obtained from a threshold determining a cluster particle size.

10. The method of claim 7, further comprising:
setting a threshold for distance between a center of a cluster and a data point permitted to be included in the cluster, at a value inversely proportional to a square root of a weight of a representative point; and
performing clustering processing on a group of representative points including the two representative points into which the new representative point has been split, by using the threshold.

11. The method of claim 7, further comprising:
selecting first and second representative points from among a group of representative points including the two representative points into which the new representative point has been split;
determining whether a first expectation value of an objective function which is obtained by integrating the first and second representative points into an integration-destination representative point is equal to or smaller than a second expectation value of the objective function which is obtained without integrating the first and second representative points into the integration-destination representative point; and
integrating the first and second representative points into the integration-destination representative point when the first expectation value is equal to or smaller than the second expectation value.

12. The method of claim 11, further comprising:
defining a cost function having a value obtained by subtracting the second expectation value from the first expectation value; and
selecting the first and second representative points for which a value of the cost function is minimum among the group of representative points.

13. The method of claim 12, wherein
the first and second representative points are integrated into the integration-destination representative point when a value of the cost function for the first and second representative points is equal to or smaller than zero.

14. The method of claim 11, wherein
the first anticipate value is obtained by using:
a product of a sum of weights of the first and second representative points and an expectation value of distance between a data point belonging to the first and second representative points and the integration-destination representative point, and
an item calculated from a threshold determining the cluster particle size; and
the second expectation value is obtained by using:
a sum of:
a first product of a weight of the first representative point and an expectation value of distance between the first representative point and a data point belonging to the first representative point, and
a second product of a weight of the second representative point and an expectation value of distance between the second representative point and a data point belonging to the second representative point, and
an item calculated from the threshold determining the cluster particle size.

15. The method of claim 12, wherein
a value of the cost function is obtained by subtracting an item calculated from the threshold, from a sum of:
a first product of a weight of the first representative point and a distance between the first representative point and the integration-destination representative point, and
a second product of a weight of the second representative point and a distance between the second representative point and the integration-destination representative point.

16. The method of claim 14, further comprising:
storing information on the first and second representative points before integration in which the first and second representative points are integrated into the integration-destination representative point, wherein
the first product and the second product are calculated by using an error indicating a difference between a first distance between a data point and a representative point before the integration, and a second distance between the data point and the integration-destination representative point.

17. The method of claim 14, further comprising:
selecting one of the first and second representative points as the integration-destination representative point; and
upon finishing an operation for the integration, re-calculating coordinates of the integration-destination representative point by using information on the integration-destination representative point.

18. The method of claim 17, wherein
a value of the cost function is obtained by subtracting an item calculated from the threshold, from a product of a weight of an integration-source representative point is to be integrated into the integration-destination representative point, and a distance between the integration-source representative point and the integration-destination representative point.

19. An apparatus for clustering data in streaming clustering, the apparatus comprising:
a processor configured to:
divide a feature value space in which input data points are to be disposed, into a plurality of local regions,
determine a representative point independently for each of one or more local regions each including at least one data point,
in a case where a data point is added to a local region in which the representative point is disposed, determining a new representative point to which a weight is assigned, based on the added data point and the representative point, and
control a number of clusters by using the new representative point; and
a memory coupled to the processor, configured to store information on representative points included in the one or more local regions.

20. A non-transitory, computer-readable recording medium having stored therein a program for causing a computer to execute a process, the process comprising:
dividing a feature value space in which input data points are to be disposed, into a plurality of local regions;
determining a representative point independently for each of one or more local regions each including at least one data point;
in a case where a data point is added to a local region in which the representative point is disposed, determining a new representative point to which a weight is assigned, based on the added data point and the representative point; and
controlling a number of clusters by using the new representative point.
